(19) United States
(12) Patent Application Publication
(10) Pub. No.: US 2026/0154757 A1
(43) Pub. Date: Jun. 4, 2026

(54) FISHERIES LOCATION ASSESSMENT SYSTEM AND METHOD

(71) Applicant: Blue Latitudes, LLC, Laguna Beach, CA (US)

(72) Inventors: Amberlea SPARKS, Laguna Beach, CA (US); Emily HAZELWOOD, Durham, NH (US)

(21) Appl. No.: 19/407,345

(22) Filed: Dec. 3, 2025

Related U.S. Application Data
(60) Provisional application No. 63/727,796, filed on Dec. 4, 2024.

(51) Int. Cl. G06Q 50/02; G06Q 30/018

(52) U.S. Cl. CPC G06Q 50/02; G06Q 30/018

(57) ABSTRACT

Systems and methods are presented for assessing environmental, fisheries-related, and economic impacts of offshore infrastructure development and decommissioning projects. A server processor receives marine data for a plurality of sites and processes the data to generate predictive models classifying the data by predicting environmental conditions that meet or fail to meet, in accordance with one or more rules and thresholds, regulatory or industry criteria. The server processor further receives a dataset of marine data for a specified site, presents the dataset to ML algorithms using the predictive models and rules to generate output including a suitability ranking of the site as meeting or failing to meet the criteria. A user device processor reviews, with a plurality of GUIs, the generated output for the specified site, updates values within the dataset, and requests that the server processor reprocesses the updated dataset simulating development and/or decommissioning scenarios to generate new output.

### CROSS-REFERENCE TO RELATED APPLICATIONS

This application is a non-provisional application of, claims benefit of, and priority under 35 U.S.C. §119(e) to, co-pending and commonly owned U.S. Provisional Patent Application Serial No. 63/727,796, filed on December 04, 2024, titled “FISHERIES LOCATION ASSESSMENT SYSTEM AND METHOD,” which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### FIELD OF THE INVENTION

The present disclosure relates to systems, methods, and computer program products for assessing offshore infrastructure development and decommissioning projects and for determining rules-based ratings, rankings, and/or scoring of suitability of environmental, fisheries-related, and economic impacts of current and/or proposed offshore infrastructure and, in particular, to systems, methods, and computer program products that use spatial planning tools and predictive modeling to assess and to determine rules-based ratings of suitability of environmental, fisheries-related, and economic impacts of the current and/or proposed offshore infrastructure development and/or decommissioning project for regulatory compliance, effective development and/or decommissioning planning, mitigation of environmental impacts, and/or stakeholder alignment, for example, agreement with stakeholder priorities and/or goals, as reflected in and supported by decisions within projects for site development and/or decommissioning.

### BACKGROUND OF THE INVENTION

This description of related art is provided to generally present context of the present disclosure. Unless otherwise indicated, the information described in this section is not prior art to the claimed invention of this patent document and is not admitted to be prior art by inclusion therein.

There are existing spatial planning tools on the market to help stakeholders and other decision makers collect and assess data for offshore infrastructure development and decommissioning projects. But these conventional systems and the resources they attempt to provide create problems as there are too many of them. As such, there exists no “true” all-in-one solution. As a result, stakeholders and decision makers are left with a high volume of data collected that must be filtered without relevant interpretations to inform their projects. Not only are the conventional approaches less convenient and result in more time intensive tasks, but the conventional approaches are seen to prevent environmentally responsible installation and decommissioning projects in the world’s oceans.

Historically, oil, gas, and wind energy platforms have been placed in oceans without a complete understanding of their impacts as artificial reef habitats for marine life. More recently, it is understood that these offshore infrastructures become artificial reef habitats that support economically valuable commercial and recreational fisheries. This finding has shifted policy makers’ and other stakeholders’ understanding of the most environmentally sensitive way to decommission these infrastructures. While there are various environmentally sensitive decommissioning and development options available, the effort needed to collect, review, categorize, forecast, and assess the data necessary to demonstrate the value of these more environmentally sensitive options is difficult using conventional systems and methods.

Accordingly, the inventors have discovered that there is a need for improved computer systems, methods, and computer program products that integrate data collected for decommissioning and/or development of offshore infrastructure including, for example, energy exploration, generation, and production platforms (e.g., oil, gas, and wind platforms) and for other man-made offshore infrastructures in general, that provide the integrated data, including data from spatial mapping tools, to one or more artificial intelligence (AI) and machine language (ML) models that use algorithms to analyze the data to produce and/or generate output including predictions, ratings, rankings, or scoring, in accordance with predetermined rules relative to meeting or failing to meet predetermined criteria, and/or decisions that can be directly interpreted and used by the stakeholders to forecast and assess results representative of a suitability of one or more sites of offshore infrastructure that meet or fail to meet their siting, regulatory compliance, and development and/or decommissioning planning requirements, thereby facilitating more environmentally responsible development, installation, and decommissioning projects within the world’s oceans.

### SUMMARY OF THE INVENTION

The present disclosure describes, in one aspect, a system for assessing environmental, fisheries-related, and economic impacts of offshore infrastructure development and decommissioning. In some embodiments, the system includes a server having a server processor and a server memory operatively coupled to the server processor. The server memory stores server instructions that are executable by the server processor. The system also includes one or more user devices that are operable by one or more users of the system, each of the one or more user devices includes a user device processor, a user device memory operatively coupled to the user device processor, and a user device display operatively coupled to the user device processor. The user device display may exhibit a plurality of graphical user interfaces thereon. The one or more user devices communicate with the server over a communication network. Each of the user device memory stores user device instructions executable by the user device processor.

The server processor, when executing the server instructions, is configured to receive, over the communication network, unclassified marine data for a plurality of sites of interest and to pre-process the received unclassified marine data to generate one or more predictive models including classified data representative of generated predictions of environmental conditions and a generated degree in which the predicted environmental conditions at least one of meets or fails to meet, in accordance with one or more sets of rules and within one or more predefined thresholds, at least one of regulatory criteria or industry criteria. The server process, when executing the server instructions, is also configured to receive a dataset of unclassified marine data for a specified site of interest, and to present the received dataset of unclassified marine data for the specified site to one or more ML algorithms that use the one or more sets of rules and the generated one or more predictive models to evaluate the received dataset and to generate, in accordance with the one or more sets of rules, a suitability ranking for the specified site of interest for development or decommissioning based on a comparison to the generated predictions of environmental conditions and including within the suitability ranking a generated degree that the specified site meets or fails to meet, within at least one of the predefined thresholds, the at least one of regulatory criteria or industry criteria. The server processor, when executing the server instructions, is further configured to host the plurality of graphical user interfaces operable to review the generated suitability ranking and generated degree of meeting or failing to meet the regulatory or industry criteria for the specified site of interest.

The user device processor, when executing the user device instructions, is configured to review, by invoking one of the plurality of graphical user interfaces, the generated output for one or more of the specified sites of interest, and to update, by invoking one of the plurality of graphical user interfaces, a value of within the dataset of unclassified marine data, to generate a request to the server processor to reprocess the updated dataset of unclassified marine data to simulate one or more scenarios for development and/or decommissioning and to thereby generate a new suitability ranking and a degree of meeting or failing to meet the regulatory or industry criteria in response thereto.

The present disclosure also describes, in another aspect, a method for assessing environmental, fisheries-related, and economic impacts of offshore infrastructure development and decommissioning. In some embodiments, the method includes providing a server processor and a server memory operatively coupled to the server processor. The server memory stores server instructions executable by the server processor. The method also includes providing one or more user devices each including a user device processor, a user device memory operatively coupled to the user device processor, and a user device display operatively coupled to the user device processor and exhibiting a plurality of graphical user interfaces thereon. The one or more user devices communicate with the server over a communication network. Each of the user device memory stores user device instructions executable by the user device processor.

The method further includes receiving, by the server processor, unclassified marine data for a plurality of sites of interest and pre-processing the received unclassified marine data to generate one or more predictive models including classified data representative of predicted environmental conditions that meet or fail to meet, in accordance with one or more sets of rules and within one or more predefined thresholds, at least one of regulatory criteria or industry criteria. The method further includes receiving, by the server processor, a dataset of unclassified marine data for a specified site of interest, presenting the received dataset of unclassified marine data for the specified site to one or more ML algorithms that use the one or more sets of rules and the generated one or more predictive models to evaluate the received dataset and to generate, in accordance with the one or more sets of rules, output representative of a suitability of the specified site of interest for development or decommissioning based on the predicted environmental conditions at the specified site meeting or failing to meet, within at least one of the predefined thresholds, the at least one of regulatory criteria or industry criteria. The method also includes hosting, by the server processor, the plurality of graphical user interfaces operable to review the generated output for the specified site of interest. The method also includes reviewing, by the user processor invoking one of the plurality of graphical user interfaces, the generated output for the specified site of interest, updating, by invoking one of the plurality of graphical user interfaces, a value of within the dataset of unclassified marine data, and generating, by the user processor, a request to the server processor to reprocess the updated dataset of unclassified marine data to simulate one or more scenarios for development and/or decommissioning and generation new output in response thereto.

The present disclosure also describes, in yet another aspect, a computer program product that, when executed, causes a processor of a computing device to assess environmental, fisheries-related, and economic impacts of offshore infrastructure development and decommissioning. In some embodiments, execution of the computer program product includes receiving, by a server processor, unclassified marine data for a plurality of sites of interest and pre-processing the received unclassified marine data to generate one or more predictive models including classified data representative of predicted environmental conditions that meet or fail to meet, in accordance with one or more sets of rules and within one or more predefined thresholds, at least one of regulatory criteria or industry criteria. Execution further includes receiving, by the server processor, a dataset of unclassified marine data for a specified site of interest, presenting the received dataset of unclassified marine data for the specified site to one or more ML algorithms that use the one or more sets of rules and the generated one or more predictive models to evaluate the received dataset and to generate, in accordance with the one or more sets of rules, output representative of a suitability of the specified site of interest for development or decommissioning based on the predicted environmental conditions at the specified site meeting or failing to meet, within at least one of the predefined thresholds, the at least one of regulatory criteria or industry criteria. The execution also includes hosting, by the server processor, the plurality of graphical user interfaces operable to review the generated output for the specified site of interest. The execution of the computer program product also includes reviewing, by a user processor invoking one of the plurality of graphical user interfaces, the generated output for the specified site of interest, updating, by invoking one of the plurality of graphical user interfaces, a value of within the dataset of unclassified marine data, and generating, by the user processor, a request to the server processor to reprocess the updated dataset of unclassified marine data to simulate one or more scenarios for development and/or decommissioning and generation new output in response thereto.

### BRIEF DESCRIPTION OF THE DRAWINGS

The features and advantages of the present disclosure are better understood when the Description of the Preferred Embodiments given below is considered in conjunction with the figures provided herein and illustrating exemplary embodiments, wherein:

FIG. 1 illustrates an example, non-limiting, schematic block diagram of a fisheries location assessment technology system, according to some embodiments;

FIGS. 2 to 4 illustrate example, non-limiting, schematic block diagrams depicting data processing of the system of FIG. 1, according to some embodiments;

FIG. 5A depicts an example, non-limiting of a Site Selection graphical user interface (GUI) operable to select a site of interest for evaluation by the fisheries location assessment technology system of FIG. 1 and invoking features and functions of the system, according to some embodiments;

FIG. 5B depicts an example, non-limiting of a Site Comparison GUI operable to exhibit for comparison two existing ones of the sites or areas of interest and the data thereof, according to some embodiments;

FIG. 5C depicts an example, non-limiting of a Create Site Recommendation GUI operable to define two or more existing sites for an on-demand, rule-based rank order analysis of suitability of the sites under evaluation for development and/or decommissioning project planning, according to some embodiments;

FIG. 5D depicts an example, non-limiting of a Site Ranking Report GUI exhibiting the generated ranking invoked by the Create Site Recommendation GUI of FIG. 5C, according to some embodiments;

FIG. 6A depicts an example, non-limiting of an Overview GUI exhibiting marine data associated with a selected site of interest under evaluation by the fisheries location assessment technology system of FIG. 1 and invoking features and functions of the system, according to some embodiments;

FIG. 6B depicts an example, non-limiting of an Add Sites GUI operable to add one or more sites of interest for a comparison to a site currently presented on GUI such as the Overview GUI of FIG. 6A, according to some embodiments;

FIG. 7 depicts an example, non-limiting a Fisheries GUI exhibiting usage data associated with a selected site of interest under evaluation by the fisheries location assessment technology system of FIG. 1 and invoking features and functions of the system, according to some embodiments;

FIG. 8 depicts an example, non-limiting a Vessel Traffic GUI exhibiting marine data and vessels in proximity to a selected site of interest under evaluation by the fisheries location assessment technology system of FIG. 1 and invoking features and functions of the system, according to some embodiments;

FIG. 9 depicts an example, non-limiting a Habitat GUI exhibiting habitat and species data for a selected site of interest under evaluation by the fisheries location assessment technology system of FIG. 1 and invoking features and functions of the system, according to some embodiments;

FIG. 10 depicts an example, non-limiting a Marine Life GUI exhibiting measures of probability of encountering various marine species and an estimate of species connectivity to a selected site of interest under evaluation by the fisheries location assessment technology system of FIG. 1 and invoking features and functions of the system, according to some embodiments;

FIGS. 11 to 13 depict example, non-limiting, GUIs exhibiting portions of a report for a specified site of interest under evaluation by the fisheries location assessment technology system of FIG. 1, according to some embodiments;

FIG. 14 depicts example, non-limiting Species Presence Report generated and output by the fisheries location assessment technology system of FIG. 1, according to some embodiments;

FIG. 15 depicts an example, non-limiting Species Richness Report generated and output by the fisheries location assessment technology system of FIG. 1, according to some embodiments; and

FIG. 16 depicts an example, non-limiting Reefing Suitability Report generated and output by the fisheries location assessment technology system of FIG. 1, according to some embodiments.

In these figures, like structures are assigned like reference numerals but may not be referenced in the description of all figures.

### DETAILED DESCRIPTION OF PREFERRED EMBODIMENTS

### Introduction

The present disclosure describes novel and non-obvious systems, methods, and computer program products that collect data, including marine data at one or more areas or sites of interest, retrieved or received from spatial planning and/or mapping tools, provide the collected data to one or more AI and ML based learning and prediction models that may be trained and utilized by ML algorithms to classify one or more of states, conditions, operations, or behaviors at the sites to generate, predict, and/or demonstrate environmental, fisheries-related, and/or economic impacts of current and/or proposed offshore infrastructure development (e.g., newly installed sites or equipment, and/or improvements to existing sites or equipment) and decommissioning projects at the sites, and in some embodiments, with a generated rating, ranking, and/or score for the sites based upon specified rules to define suitability of the sites in meeting, or failing to meet, levels or thresholds of at least one of regulatory and/or industry criteria. In some embodiments, the ML algorithms may also generate and provide economic impacts of the current and/or proposed offshore infrastructure development and decommissioning projects including, for example, cost of the project itself and projected or forecasted long term revenue and/or other financial benefits derived directly and/or indirectly from the siting or decommissioning project. In some embodiments, benefits can include, for example, cost avoidance by, for example, identifying savings associated with alternative decommissioning strategies such as reefing-in-place versus full removal of infrastructure of the offshore site, and/or by, for example, reducing a need for sediment remediation or habitat restoration if infrastructure is repurposed to enhance its ecological function. Benefits may also include, for example, enhanced fisheries productivity by, for example, increasing commercial and recreational fishing opportunities resulting from, for example, improved habitat availability due to artificial reef creation and/or infrastructure reefing, and from, for example, improved fish stock sustainability through better-informed development and/or decommissioning decisions that, for example, may minimize impacts on critical spawning and/or nursery habitats. Still further benefits may include, for example, revenue from tourism and/or recreational use by, for example, providing new and/or expanded ecotourism and dive tourism opportunities associated with decommissioned platforms and/or reefed structures, and by, for example, attraction of recreational anglers, divers, and nature enthusiasts to repurposed sites that may, for example, generate income for local businesses.

In some embodiments, the AI- and ML-based models are employed to generate predictions of biodiversity and probability of a presence of one or more specified marine species at one or more specified sites. In some embodiments, the specified marine species focus upon commercially and/or recreationally valuable fish and/or other marine species by, for example, assessing their probability of presence, namely, a likelihood of encountering a given species at a specific site and time. In some embodiments, key species are selected based on their occurrence rates in, for example, historical data. In some embodiments, for any particular site, the systems and methods of the present disclosure generate a tailored list of species relevant to the site’s depth and environmental conditions. It should be appreciated that while described as focusing upon commercially and/or recreationally valuable fish, the systems and methods of the present disclosure may be adapted to include other types of marine life and/or broader ecological indicators in future evaluations. In some embodiments, ecological indicators may include, for example, the presence and/or abundance of marine life such as, for example, threatened or endangered species such as, for example, sea turtles or marine mammals. Ecological indicators may also include, for example, a diversity and/or density of benthic invertebrate communities such as, for example, corals, sponges, crustaceans, and others. Ecological indicators may further include, for example, bioindicator species linked to, for example, ecosystem health and/or pollution tolerance, larval dispersal patterns of non-target species, and habitat use by, for example, migratory species and/or keystone species (e.g., an organism that helps define an ecosystem). As should be appreciated, in some embodiments, the ecological indicators may support expanded uses of the systems and methods described in this disclosure, such as, for example, habitat restoration planning, marine protected area design, biodiversity offsetting, and/or cumulative impact assessments.

In some embodiments, the generated output from the models and the rules-based definition of suitability rating, ranking, and/or scoring of subject sites can be used by stakeholders in development and decommissioning projects to support their development, regulatory compliance, effective development and/or decommissioning planning, mitigation of environmental impacts, and/or stakeholder alignment, for example, agreement with stakeholder priorities and/or goals as reflected in and supported by decisions within projects for site development and/or decommissioning. In some embodiments, stakeholders may include, for example, offshore oil and gas companies, fisheries non-governmental organizations (NGOs) such as, for example, National Fish and Wildlife Foundation, Environmental Defense Fund, Nature Conservancy, and others, as well as regulators. Other stakeholders may include offshore industries such as, for example, offshore nuclear, wind companies, and the like, academic research and environmental monitoring institutions, commercial fisheries management companies. In some embodiments, the AI- and ML-based models may generate predictions of how the removal, decommissioning in place (i.e., reefing), or installation of offshore infrastructure may impact the environment and fisheries, for example, by predicting where to install/site or develop (e.g., improve), reef (e.g., decommission while preserving in place and ceasing energy generating operations), or remove structures from their current location to maximize benefits to fisheries (e.g., commercial and/or recreational) and the surrounding environment, while minimizing risk and cost within the industry thereby providing a rules-based definition of suitability rating, ranking, and/or scoring of subject sites to inform and to facilitate stakeholder decision making, for example, to encourage, to assist, and/or to provide more environmentally responsible installation and decommissioning projects within the world’s oceans.

In one embodiment, the systems, methods, and computer program products described herein are implemented in a Fisheries Location Assessment Technology (FishLAT^{TM}) system that includes a server having a server processor and a server memory operatively coupled to the server processor. The server memory stores server instructions executable by the server processor. FishLAT is a trademark of Blue Latitudes, LLC of Laguna Beach, California. The system also includes one or more user devices, operable by one or more users of the system. Each of the one or more user devices have a user device processor, a user device memory operatively coupled to the user device processor, and a user device display operatively coupled to the user device processor. The user device display exhibits a plurality of graphical user interfaces (GUIs) thereon. The one or more user devices communicate with the server over a communication network. Each of the user device memories store user device instructions executable by the user device processor.

In one aspect of the present disclosure the server processor, when executing the server instructions, is configured to receive or retrieve marine data, e.g., over the communication network, and to integrate the data within the FishLAT system to define qualities and/or characteristics of one or more areas under consideration or sites of interest. In some embodiments, the marine data may include physical characteristics of areas or sites of interest including, for example, depth, substrate type, sediment composition and the like, environmental conditions of the areas or sites of interest including, for example, water temperature, salinity, water quality, and the like, marine life data at the areas or sites of interest including, for example, species presence, species absence, and the like, infrastructure data at the areas or sites of interest including, locations and types of existing or proposed infrastructure such as, for example, oil platforms, piping, artificial reefs, lease blocks (e.g., authorized areas for exploration, development, and/or production of energy or other resources), and like man-made structures installed in marine environments. In some embodiments, the marine data includes fishing tracking data provided by, for example, a third-party source such as, for example, the National Oceanographic and Atmospheric Administration (NOAA).

The server processor is further configured to store, within the server memory or a local or network data storage device, a site profile for each of the areas or sites of interest. In some embodiments, the site profile includes the received or retrieved marine data. As described herein, the FishLAT system presents the received or retrieved marine data to one or more ML algorithms to build or generate one or more ML models that the system trains and deploys to interpret and evaluate new datasets for one or more specified areas or sites of interest for development or decommissioning and to generate output including, for example, rules-based definitions of suitability rating, ranking, or scoring for the one or more specified areas or sites for such development or decommissioning projects based on generated predictions of environmental conditions at the specified one or more sites meeting or failing to meet, in accordance with a specified set or sets of rules, one or more regulatory criteria or industry criteria for a region including the specified areas or sites of interest. In some embodiments, the rules-based suitability rating, ranking, or scoring as meeting or failing to meet specified criteria is determined in relation to, for example, one or more predetermined levels or thresholds of acceptability at or above which defines meeting the criteria and below which defines failing to meet the criteria. In some embodiments, the site profile also includes the generated output including maps, ratings, rankings, scores, indices, and the like, as described herein, to provide an assessment of the area or site of interest for compliance with the regulatory criteria or industry criteria. For example, in some embodiments, the generated output may include evaluations as to whether one or more proposed projects meet regulatory or industry criteria within a defined region, investigations including scenarios and predictions of stakeholder behavioral changes resulting from placement of marine infrastructure (e.g., platforms, wind turbines, and the like man-made structures), assessments generated by applying specified rules to define the suitability of a site (e.g., ratings, rankings, and/or scorings of suitability relative to meeting or failing to meet regulatory and/or industry criteria for comparison among proposed sites and/or to one or more specified minimum thresholds of acceptability) for the installation of infrastructure, and reports generated to provide ecological and stakeholder baseline data at specific sites, aiding in project planning and permitting processes. As described herein, the FishLAT system may be used to evaluate the feasibility of repurposing offshore infrastructure (e.g., oil and gas platforms, or wind turbines, and the like) as artificial reefs under existing programs such as, for example, the Rigs-to-Reefs program, where such infrastructure is recognized as a habitat supporting marine life to the benefit of commercial and/or recreational fisheries and others. For example, the FishLAT system is seen to generate rules-based assessments and other output to enhance and improve the process of designating new reefing sites, assessing offshore energy lease blocks, and informing installation or decommissioning of offshore energy infrastructure, such as wind turbines and oil and gas platforms. By integrating region-specific regulatory requirements into its rules-based and modeling framework, the FishLAT system generates actionable insights that align with environmentally, fiscally, and socially responsible goals.

In some embodiments, the server processor is also configured, by executing the server instructions, to generate and output impact assessments, exploration and/or decommissioning scenarios, rules-based suitability ratings, rankings, and/or scoring, and baseline assessments. In some embodiments, within its process of generating the rules-based definitions and impact assessments, the FishLAT system synthesizes diverse datasets to evaluate, with precision, whether proposed projects meet regulatory criteria within one or more defined regions. The generated and outputted assessments are seen to enable stakeholders to make more informed decisions regarding infrastructure development while adhering to legal and environmental standards. In some embodiments, within its process of generating exploration, development, and/or decommissioning scenarios, functionality of the FishLAT system can be used to explore various scenarios including, for example, predictions of stakeholder behavior changes resulting from the placement of infrastructure such as, for example, artificial reefs, wind turbines, oil and gas platforms, aquaculture farms, or other marine infrastructure. This functionality of the FishLAT system is seen to help anticipate and mitigate potential conflicts and optimize site selection within, for example, numerous possible options. In some embodiments, within its process of generating and outputting rules-based suitability rankings, the FishLAT system provides rankings that support the development of infrastructure such as, for example, artificial reefs and wind turbines. By considering impacts on fish habitat and fisheries stakeholders, these rules-based suitability rankings facilitate more informed decision-making that balances environmental concerns that may be of concern to, for example, regulatory agencies and others, with economic interests that may be of concern, for example, within the industry and/or stakeholders. In some embodiments, within its process of generating baseline assessments, the FishLAT system provides an ability to generate and output detailed reports on ecological and stakeholder baseline data at specific sites, aiding in project planning and permitting processes.

In some embodiments, the server processor is also configured, by executing the server instructions, to store the generated impact assessments, exploration, development, and/or decommissioning scenarios, rules-based suitability ratings, rankings, and/or scoring, and baseline assessments in the site profile and to update and modify the site profiles as new marine data and/or new impact assessments, exploration, development and/or decommissioning scenarios, rules-based suitability rating, rankings, and/or scoring, and baseline assessments are generated for the site. In some embodiments, the server processor may also update the stored area or site profile in response to a request generated by one of the one or more user device processors. The server processor is also configured, by executing the server instructions, to host the plurality of GUIs for monitoring and updating either the stored site profile or requesting generation of new impact assessments, exploration, development, and/or decommissioning scenarios, rules-based suitability ratings, rankings, and/or scoring, and baseline assessments are generated for the area or site of interest within the FishLAT system.

In another aspect of the present disclosure, the user device processor, when executing the user device instructions, is configured to monitor and review, by invoking one of the plurality of GUIs, the area or site profiles and progress in the generation of impact or baseline assessments, and rules-based suitability rating, rankings, and/or scoring, and to initiate exploration and/or decommissioning scenarios where, for example, one or more attributes of the marine data is changed and new assessments, rules-based rating, rankings, and/or scoring, or scenarios are generated and outputted. The user device processor, when executing the user device instructions, is further configured to generate the request to the server processor to update the stored area or site profile to include the newly generated assessments, rules-based suitability rankings, or scenarios.

### System Overview

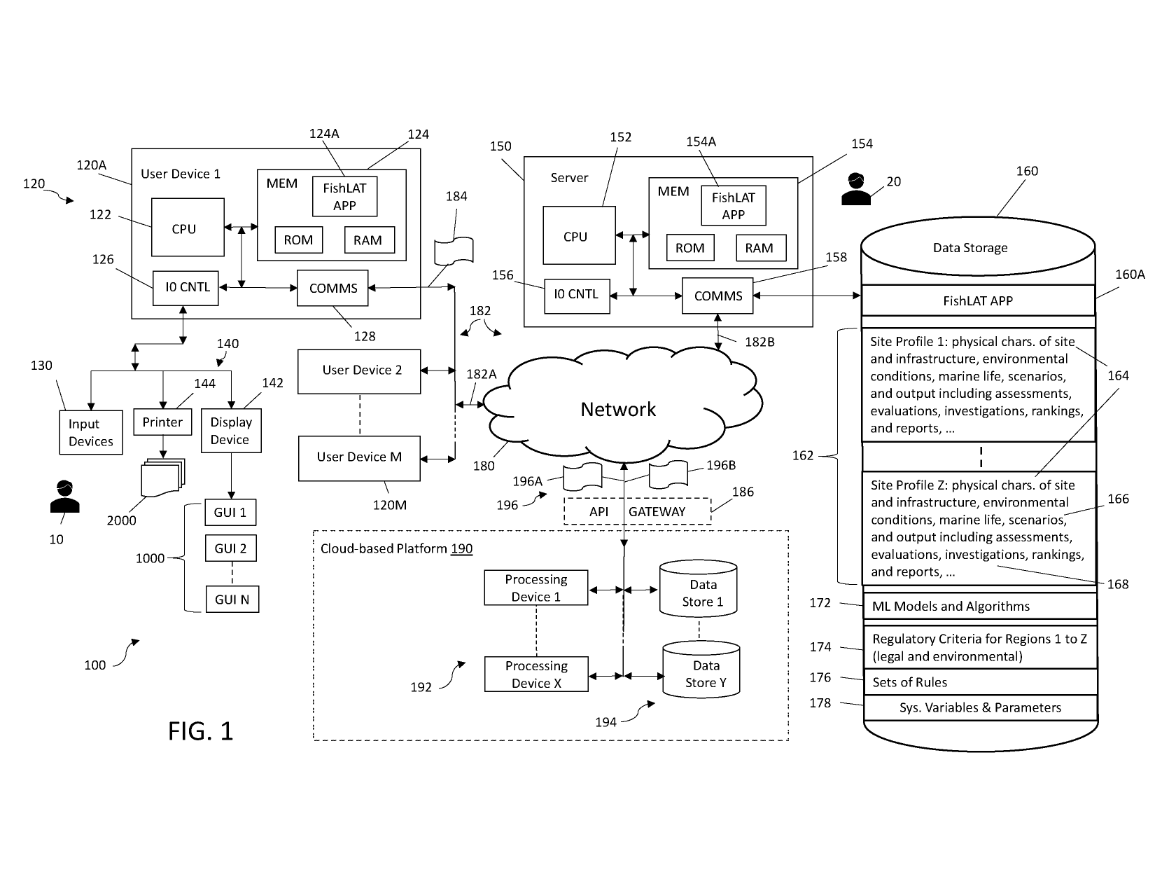

In various embodiments, a Fisheries Location Assessment Technology (FishLAT) system 100 and application, illustrated in FIG. 1, are presented. Within the FishLAT system 100 one or more clients or customers and others, referred to hereinafter as “users” and shown generally at 10, operate a plurality of stationary and/or portable communication and/or computing devices (exemplary devices described below) referred to hereinafter as user devices shown generally at 120. The plurality of user devices 120, including user devices 120A (labeled “User Device 1”) to 120M (labeled “User Device M”), are each capable of receiving, processing, displaying, and transmitting input and output such as, for example, marine data, location information (e.g., longitude and latitude) for one or more areas or sites of interest, characteristics of the areas or sites of interest, environmental conditions, marine life, exploration, development, and/or decommissioning scenarios, and generated output including impact and baseline assessments, evaluations, rules-based suitability rankings, and reports of one or more of the areas or sites of interest, as well as system preferences, and other messages or control signals, and the like, over wired or wireless communication connections shown generally at 182 (e.g., connections 182A) via a network 180 such as, for example, a local area network (LAN), an intranet, extranet, the Internet, or other distributed communication network, to other devices (described below) operatively coupled to the communication network 180. The marine data, characteristics of the areas or sites of interest, environmental conditions, marine life, exploration, development, and/or decommissioning scenarios, and the generated output including impact and baseline assessments, evaluations, rules-based suitability rankings, and reports of one or more of the areas or sites of interest, messages, system preferences, and other messages, commands, or control signals distributed within the FishLAT system 100 are illustrated in FIG. 1 generally at 184.

In some embodiments, users 10 of the system 100 operating the user devices 120, may be granted differing authorizations or permissions and/or levels thereof, to execute various ones of the features and/or functions of the FishLAT system 100 as described herein. For example, the authorizations or permissions may specify whether a user 10 may access and/or manipulate, e.g., perform operations upon, data and information stored and/or processed within the system 100 such as, for example, invoking functionality presented on one or more graphical user interfaces described herein. For example, in some embodiments the user 10 may be permitted to only view data and information in the system 100, whereas one or more system administrators 20, one administrator shown in FIG. 1, may be permitted to view, update, add, or delete data and information in the system 100. In some embodiments, the users 10 and system administrators 20 of the system 100 enter login credentials (e.g., username and password, or other information to authenticate or verify the identity of a user or administrator), that the system 100 verifies and, once accepted, controls access to the functionality of the system 100.

In one embodiment, each of the user devices 120 includes or is operatively coupled via the network 180 to one or more processors (CPU) 122, memory (e.g., internal memory (MEM) 124 including hard drives, ROM, RAM, and like non-transitory, computer readable storage medium), and/or data storage (e.g., hard drives, optical storage devices, and like non-transitory, computer readable storage medium) as is known in the art. In one embodiment, each of the user devices 120 includes or is operatively coupled to one or more input devices 130 and one or more output devices, shown generally at 140, via an input/output controller (IO CNTL) 126. In one embodiment, the input devices 130 include, for example, a keyboard, mouse, stylus, or like pointing device, buttons, wheels, touch pad, or touch screen portions of a display device, or input ports, and/or combinations thereof, for receiving and providing data and information to the user device 120, e.g., within the messages 184. In one embodiment, the output devices 140 include, for example, one or more display devices 142 integral with or operatively coupled to the user device 120 to visually exhibit input and/or output, a speaker (now shown) to provide audio output, and/or a printer 144 to provide printed output. In one embodiment, the visual and printed input and/or output may include documents, images, and other visual representations of the data and information within the system 100 including, for example, the marine data, the characteristics of the area or site of interest, the environmental conditions, the marine life, the exploration, development, and/or decommissioning scenarios, and the generated output including the impact assessments and the baseline assessments, the evaluations, the rules-based suitability rankings, and the reports of one or more of the areas or sites of interest. In one embodiment, the audio and visual output may include instructional or educational materials such as, for example, audio visual training materials aim to educate users 10 on aspects of the system 100. In one embodiment, the output devices 140 including the display device 142 exhibits one or more GUIs, shown generally at 1000 and labeled GUI 1 to GUI N, that may be visually perceived by a user/operator operating one of the user devices 120. In one embodiment, the output devices 140 may also provide one or more reports 2000 that may be visually perceived by the user/operator operating one of the user devices 120, e.g., also exhibited on the display device 142, or physically output on paper by the printer 144.

It should also be appreciated that for clarity purposes, components (e.g., CPU, MEM, IO CNTL, input and output devices and the like) are depicted in FIG. 1 only with reference to User Device 1120A but equally may correspond to one or more of the other user devices 120 (User Device 2 to User Device M). In one embodiment, the user devices 120 include, for example, a personal computer or workstation, or portable computer processing devices such as, for example, a personal digital assistant (PDA), iPAD^{TM} device, tablet, laptop, mobile radio telephone, smartphone (e.g., Apple^{TM} iPhone^{TM} device, Google^{TM} Android^{TM} device, etc.), or the like. It should be appreciated that the designations Apple, iPhone, and iPad are trademarks of Apple Inc. of Cupertino, California. It should also be appreciated that the designations Google and Android are trademarks of Google LLC of Mountain View, California.

In one embodiment, the FishLAT system 100 and each of the user devices 120 may be operatively coupled to and in communication with, via the network 180, a server 150. In one embodiment, the server 150 includes one or more processors (CPU) 152, memory (e.g., internal memory (MEM) 154 including hard drives, ROM, RAM, and like non-transitory, computer readable storage medium), an input/output controller (IO CNTL) 156 for receiving and outputting data and information via input devices (not shown) and output devices (not shown) coupled thereto, and/or one or more data storage devices 160 (e.g., hard drives, optical storage devices, and the like) as is known in the art. In one embodiment, illustrated in FIG. 1, each of the user devices 120 and the server 150 include communication circuitry (COMMS) 128 and 158, respectively, such as a transceiver or network interface card (NIC), for operatively coupling the user devices 120 and the server 150 by the wired or wireless communication connections 182 (e.g., connections 182A and 182B) to the network 180, and in some embodiments to a plurality of processing devices 192 including, for example, processing devices 1 to X and/or a plurality of data storage devices 194, for example, data stores 1 to Y, also operatively coupled to and communicating with the network 180. In some embodiments, the plurality of processing devices 192 and the plurality of data storage devices 194 provide data and information, shown generally at 196, to the server 150.

It should be appreciated that, while not shown, the network 180 may include, for example, cell towers, routers, repeaters, ports, switches, and/or other network components that comprise the Internet and/or a cellular telephone network and/or Public Switched Telephone Network (PSTN), as is known in the art. It should also be appreciated that, in some embodiments, the network 180 may include or utilize, for example, components and/or resources, e.g., the server 150, the processing devices 192, and data storage devices 194, operating in a “cloud” or virtual environment, depicted at 190. It should also be appreciated that communication and transfer of data between devices coupled to the network 180 may occur through protocols operating at various Open Systems Interconnection (OSI) model layers including, for example, Transmission Control Protocol/Internet Protocol (TCP/IP) on the Transport and Internet layers and/or the Hypertext Transfer Protocol (HTTP) and interfaces such as, for example, application programming interfaces (APIs) calls, as are known to those skilled in the relevant art.

In some embodiments of the FishLAT system 100, the server 150 is connected to the communication network 180 (e.g., via connections 182B) and communicates with the user devices 120 connected with the network 180, for example, sends and receives messages 184 including the marine data, for example, the characteristics of the area or site of interest, the environmental conditions, and the marine life, as well as commands and/or control signals to initiate exploration, development, and/or decommissioning scenarios and generate output including the impact assessments and the baseline assessments, the evaluations, the rules-based suitability rankings, and the reports of one or more of the areas or sites of interest, system preferences, and other messages or control signals, and the like. In some embodiments, one or more of the plurality of processing devices 192 communicates with the server 150 directly or, when invoked, through APIs calls from the server 150 through an API Gateway 186, to provide the data and information 196 including marine data 196A within, for example, third party data sources, to the server 150. As noted above, the marine data 196A may include physical characteristics of areas or sites of interest including, for example, depth, substrate type, sediment composition and the like, environmental conditions of the areas or sites of interest including, for example, water temperature, salinity, water quality, and the like, marine life data at the areas or sites of interest including, for example, species presence, species absence, and the like, infrastructure data at the areas or sites of interest including, locations and types of existing or proposed infrastructure such as, for example, oil platforms, piping, artificial reefs, lease blocks, and the like. In some embodiments, the one or more processing devices 192 and/or data storage devices 194 may provide the third-party marine data 196A including fish tracking data provided by, for example, the National Oceanographic and Atmospheric Administration (NOAA). In some embodiments, the data and information 196 may also include notification messages 196B from third-party sources indicating a change in one or more values of data and information 196, for example, the marine data 196A, previously provided to the server 150.

In some embodiments, as shown in FIG. 1, the server 150 is configured to store, within the data storage device 160, a plurality of site profiles, shown generally at 162, for one or more areas or sites of interest in an exploration, development, and/or decommissioning project. As shown in FIG. 1, the site profiles 162 (labeled “Site Profile 1” to “Site Profile Z”) may include data and information collected as, for example, input to the system 100 and/or generated as output of the system 100 on each of the one or more areas or sites of interest within the plurality of site profiles 162. For example, the data and information input and stored in the site profiles 162, as shown at 164, may include, but is not limited to, the marine data including the physical characteristics of the area or site of interest and infrastructure currently installed or planned for installation thereon, environmental conditions, and the marine life identified thereon. The site profiles 162 may also include exploration, development, and/or decommissioning scenarios, as shown at 166. As described herein, the exploration, development, and/or decommissioning scenarios may be initiated by users 10 of the system 100 operating one of the GUIs 1000 with one of the user devices 120. The scenarios may allow simulation of impacts seen from varying different conditions at the areas or sites of interest to gage or predict possible future environmental and/or cost impacts on the site and/or local marine habitat arising from the varying conditions as well as changes to the rules-based suitability rankings for sites of interest in view of the varied conditions.

As described herein, the FishLAT system 100 collects (e.g., receives or retrieves) marine data (e.g., unclassified data) and builds or generates one or more predictive models including classified data representative of predicted environmental conditions that meet or fail to meet at least one of regulatory criteria or industry criteria. The predictive models may be used by one or more ML algorithms to evaluate a dataset received on a specified site or sites of interest and to generate output representative of a rules-based suitability or a rules-based suitability rating, ranking, or scoring (e.g., for comparing two or more sites of interest under evaluation or for comparing a site to one or more minimum thresholds of acceptability to a defined set or sets of rules and/or criteria) of the specified site or sites of interest for development or decommissioning based on the predicted environmental conditions at the specified site or sites meeting or failing to meet the at least one of regulatory criteria or industry criteria. As described in detail below, the rules-based suitability of one or more sites of interest is defined by, in some embodiments, a set of rules including one or more of four (4) rules or criteria including, for example, site ecology, probability of presence, accessibility, and predicted fishing effort. In some embodiments, other objective rules or criteria for defining suitability may include, for example, regulatory thresholds such as, for example, species protection zones, essential fish habitat designations, or exclusion zones defined by, for example, local, state, federal, and/or international policies that, for example, recognize the presences of valuable marine species or habitats and limit or prohibit exploitation thereof. In some embodiments, other objective rules or criteria for defining suitability may further include, for example, stakeholder and/or industry standards or guidelines such as, for example, operational safety margins, preferred or recommended proximity to existing infrastructure and/or shipping lanes, bathymetric or sediment conditions acceptable for development, reefing, decommissioning, or the like. The site profiles 162 may also include generated output, shown generally at 168, including impact and baseline assessments, evaluations, rules-based suitability ratings, rankings, and/or scoring, and reports of one or more of the areas or sites of interest. In some embodiments, the predictive models, referred to herein as ML models, and ML algorithms may be stored within the data storage device 160, as shown at 172. In some embodiments, the generated output 168, provided by the server 150 executing a plurality of instructions (e.g., a FishLAT software application defined below), may compare the marine data 164 of the areas or sites of interest under one or more of the exploration, development, and/or decommissioning scenarios 166, that may vary values of the marine data to simulate differing conditions, to one or more regulatory thresholds or criteria or industry criteria for the region including the area or site of interest. In some embodiments, the regulatory criteria may include legal and environmental criteria for a specified region, which is stored, as shown at 174, within the data storage device 160. In some embodiments, the FishLAT system 100 may define one or more sets of rules or criteria (described herein) used with the ML models and ML algorithms to generate the generated output 168, and the rules or criteria may be stored as shown at 176, within the data storage device 160. In some embodiments, the data storage device 160 or network memory, may also store system variables and/or parameters 178 that are used by the system 100.

In one aspect of the FishLAT system 100, the user devices 120 and the server 150 execute a plurality of programmable instructions of a multifunctional fisheries location assessment technology software application or app, e.g., the FishLAT application or app (labeled “FishLAT APP”), portions or modules thereof, 124A, 154A, or 160A, stored in local memory 124 of the user devices 120 and local memory 154 of the server 150, or network memory 160, respectively, to implement the FishLAT system 100 and features and/or functions thereof. As described herein the FishLAT APP 124A, 154A, or 160A receives and stores the marine data 164, for example, the characteristics of the one or more areas or sites of interest, the environmental conditions, and the marine life as well as commands and/or control signals within the messages 184 from, for example, the user devices 120, to initiate the exploration, development, and/or decommissioning scenarios and to generate output including the impact assessments and the baseline assessments, the evaluations, the rules-based suitability ratings, rankings, and/or scoring, and the reports of one or more of the areas or sites of interest. In some embodiments, the initiation of the exploration, development, and/or decommissioning scenarios may be invoked by operation of the GUIs 1000.

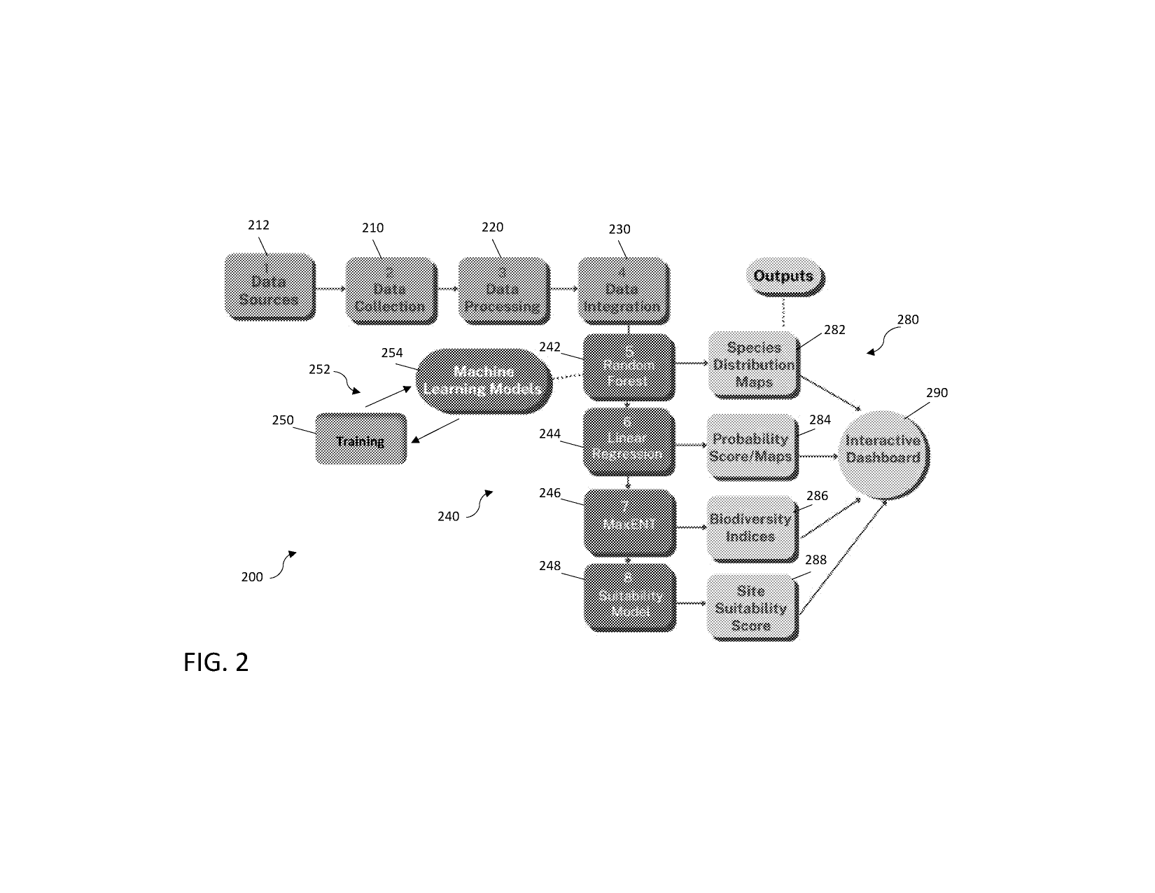

In some embodiments, the FishLAT APP 124A, 154A, or 160A employs two or more machine learning (ML) methodologies to evaluate the marine data 164 and any data input in the exploration, development, and/or decommissioning scenarios 166 to generate and/or predict, for example, biodiversity and the probability of presence of certain, targeted species at one or more specific areas or sites of interest for development and/or decommissioning. As shown in FIGS. 2 to 4, schematic, block diagrams 200, 300, and 400 depict data collection or input 210, 310, and 410, processing 220, 320, and 420, integration 230, 330, and 430, and evaluation to build ML models 254 and 448 used to generate output of the FishLAT system 100. The ML methodologies described herein leverage various ML algorithms and ML models to generate the output that permits accurate and actionable insights. As shown in FIGS. 2 to 4, core ML methodologies employed in the system 100 leverage algorithms and models, shown generally at 240, 340, and 440, such as, for example, Random Forest 242 and 342, Linear Regression 244 and 344, MaxENT (e.g., maximum entropy modeling) 246 and 346, and Suitability Models 248 and 448, to generate output, shown generally at 280, 380, and 480, such as, for example, species distribution maps 282 and 382, probability scores/maps 284 and 384, biodiversity indices 286 and 386, and site suitability rating, ranking, and/or scores 288 and 488. In some embodiments, one or more users 10 of the FishLAT system 100 may operate the FishLAT APP 124A, 154A, or 160A to exhibit the generated output 280, 380, and 480 on, for example, an interactive dashboard 290, 390, and 490. In some embodiments, the interactive dashboard 290, 390, and 490 may include one or more of the GUIs 1000 exhibited on the display device 142 of the user device 120 operated by the user 10.

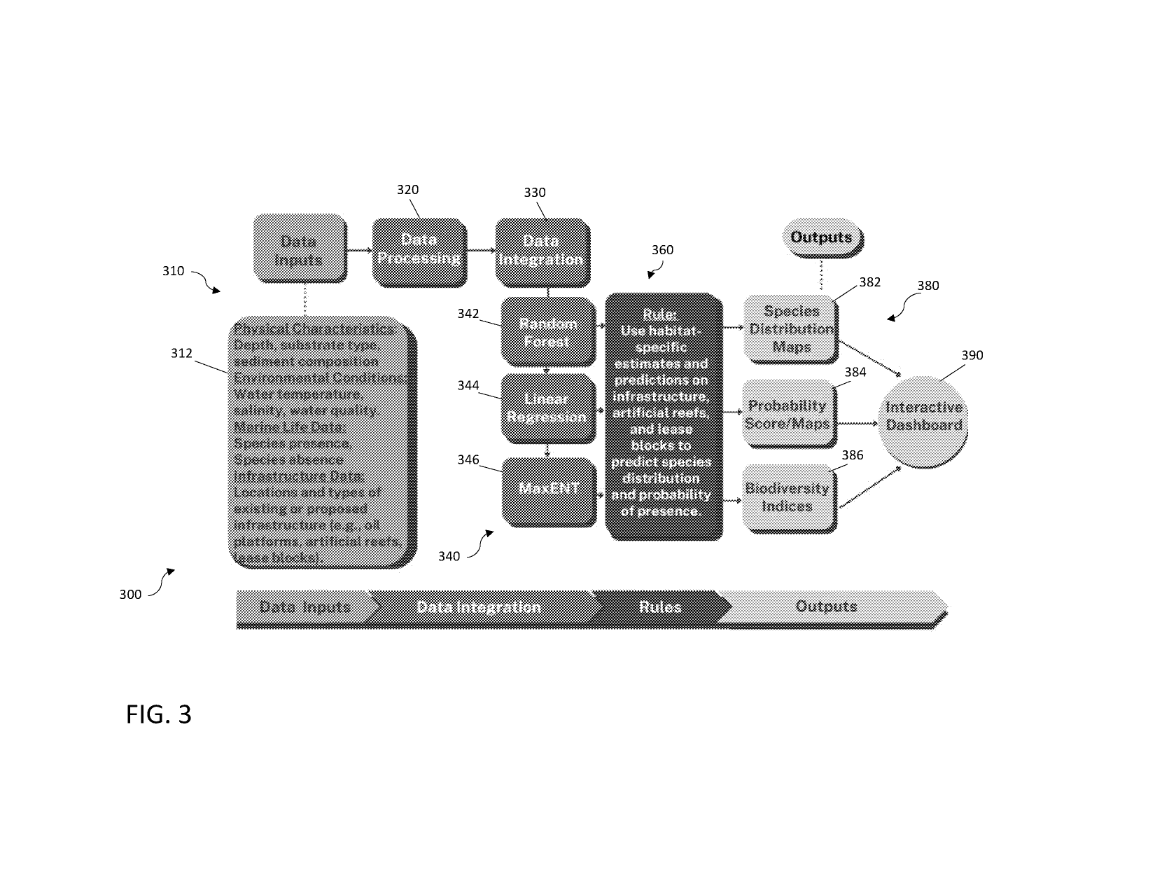

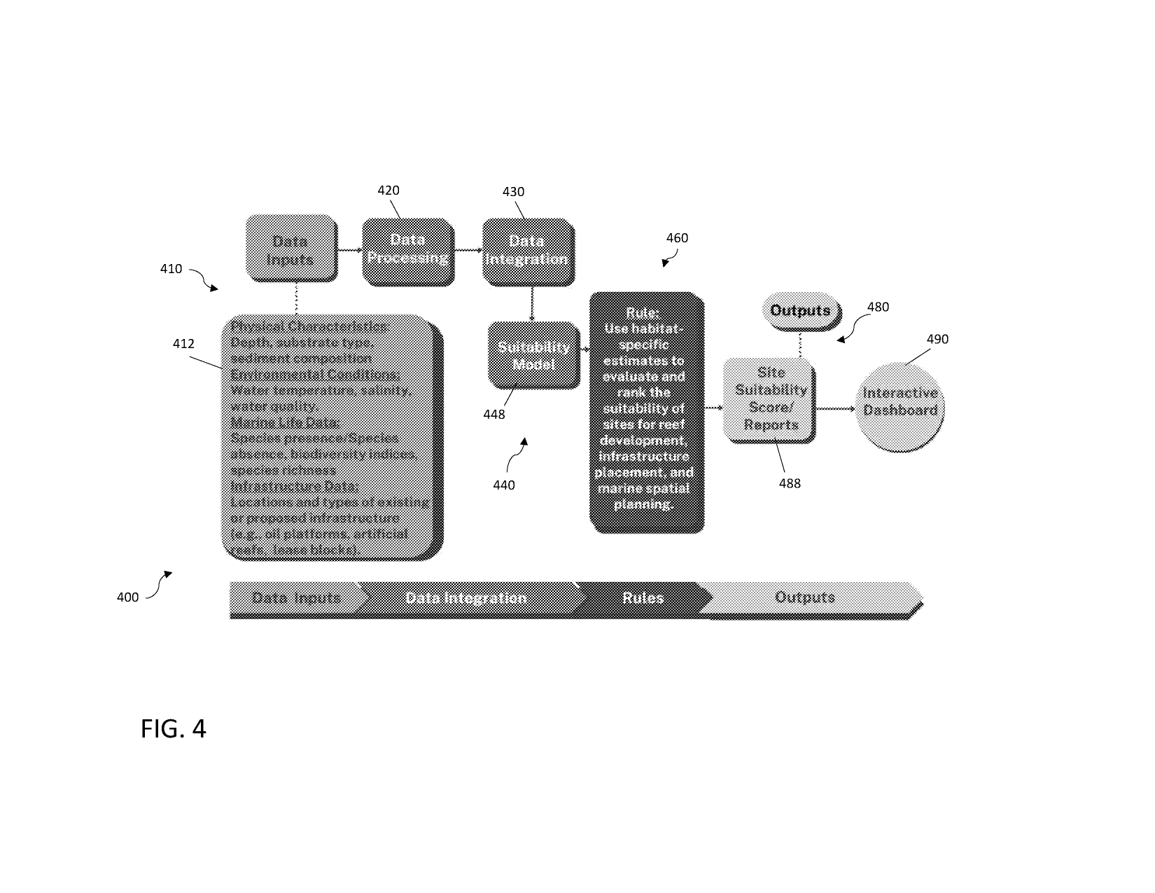

As shown in FIGS. 2 to 4, the FishLAT system 100 uses an ensemble modeling method combining output of multiple algorithms and models 242, 244, 246, 248, 342, 344, and 346 to, for example, reduce generalization errors and estimate site-specific marine species richness and probability of presence of fish and other marine species. As shown in FIGS. 3 and 4, data input, shown generally at 310 and 410, includes marine data 312 and 412 such as, for example, the physical characteristics of areas or sites of interest including, for example, depth, habitat type, substrate type, sediment composition, and other characteristics, the environmental conditions of the areas or sites of interest including, for example, water temperature, salinity, water quality, and other environmental conditions, marine life data about the areas or sites of interest including, for example, species presence and/or absence data, as well as infrastructure data including, for example, locations and types of existing or proposed infrastructure (e.g., artificial reefs, offshore platforms, structures within lease blocks, and the like), received by the FishLAT system 100 and stored by, for example, the FishLAT APP 124A, 154A, or 160A, in one of the site profiles 162 within the data storage device 160, the profile 162 corresponding to a site of interest being evaluated by the FishLAT system 100.

Referring again to FIG. 2, in a data collection process 210 the FishLAT APP 124A, 154A, or 160A of the FishLAT system 100 receives or retrieves (e.g., referred to collectively as “collects”) data from a variety of data sources 212. In some embodiments, the data sources 212 may include one or more open-source data repositories such as, for example, marine cadastre including ocean geospatial data, Bureau of Safety and Environmental Enforcement, and published literature. As is known to skilled artisans, the marine cadastre is provided by the Bureau of Ocean Energy Management (BOEM), NOAA’s National Centers for Coastal Ocean Science (NCCOS), U.S. Coast Guard Navigation Cetner, and NOAA’s Office for Coastal Management, and others. Data within the data sources 212 includes, for example, environmental variables (e.g., temperature, salinity), geographical information (e.g., depth, substrate type), and biological data (e.g., species presence records). In some embodiments, one or more of the system administrators 20 may add, change, or delete data within the FishLAT system 100.

As shown in FIGS. 2 to 4 providing an overview of processing within the FishLAT system 100, once data is collected the FishLAT APP 124A, 154A, or 160A performs data processing at 220, 320, and 420 to, for example, clean, normalize, and/or perform feature engineering upon, the collected data. In some embodiments, data cleaning includes removing noise and irrelevant information from the data collected, normalization includes scaling the data to a standard range to provide consistency within the data, and feature engineering includes selecting, transforming, and/or creating variables from the collected data in its “raw data” form to improve ML model performance. Once the collected data is processed at the data processing steps, e.g., the data processing 220, 320, and 420, the processed data is passed to a data integration step, e.g., data integration 230, 330, and 430, where the processed data from the variety of different sources is combined into a unified, predetermined format suitable for ML analysis. In some embodiments, once data integration is completed at 230, 330, and 430, the FishLAT APP 124A, 154A, or 160A performs one or more training processes, as shown at 250 of FIG. 2, to build one or more ML models, as shown at 254 of FIG. 2. It should be appreciated that it is within the scope of the present disclosure for the training processes to include supervised learning, unsupervised learning, semi-supervised learning, and other training techniques. It should also be appreciated that it is within the scope of the present disclosure that the training processes are performed initially on receipt of collected data as well as periodically, e.g., in an iterative manner as shown generally by arrows at 252, to continuously refine and update the ML models 254 used by the FishLAT APP 124A, 154A, or 160A within the FishLAT system 100. In some embodiments, the training process 250 for the ML models 254 used within the FishLAT system 100 includes steps of data splitting, model training, hyperparameter tuning, validation, and model iteration. In some embodiments, data splitting includes splitting a dataset including the collected, processed, and integrated data into training, validation, and test sets to ensure the ML models 254 are trained and evaluated properly. In some embodiments, model training includes training models using labeled data where one or more target outcomes (e.g., species presence) are known. In some embodiments, hyperparameter tuning includes adjusting parameters of the models to optimize performance. Techniques such as, for example, statistical analyses, post-hoc test, and linear regression may be used to find one or more key parameters. In some embodiments, validation may include evaluating the models on a validation set to monitor performance and substantially minimize, if not prevent, overfitting. In some embodiments, model iteration may include continuously refining and updating the ML models 254 based on new data and feedback to improve accuracy.

As described herein, the FishLAT system 100 uses the ensemble modeling methods 240, 340, and 440 combining output of multiple algorithms and models 242, 244, 246, 248, 342, 344, and 346 that use the ML models 254 and algorithms to, for example, learn and predict, by classifying one or more of states, conditions, operations, behaviors, environmental, fisheries-related, and/or economic impacts of current and/or proposed areas or sites of offshore infrastructure development and decommissioning projects and the rules-based suitability or acceptability of the areas or sites for development or decommissioning based on the predicted environmental conditions at the areas or sites as meeting or failing to meet, at predetermined levels or thresholds, regulatory criteria and/or industry criteria. In some embodiments, the output produced by the ensemble of algorithms and models generates predictions of biodiversity and probability of a presence of one or more specified marine species at one or more specified sites. For example, in some embodiments, if environmental data at a given site includes proximity to known reef structures, the algorithms and models may predict a higher likelihood of a presence for species such as, for example, Lutjanus campechanus, commonly known as a red snapper, a commercially valuable species associated with structured habitats. As should be appreciated, the predictions are based on patterns learned by evaluating, for example, historical datasets, fisheries survey data, and remotely sensed environmental variables. For example, each decision tree within the Randon Forest algorithm 222 is trained on a different subset of the data and, in some embodiments, a final prediction is made by averaging the predictions from all the decision trees. As should be appreciated, this approach is seen to reduce overfitting behavior and improving the generalization capabilities of the ML models 254 and the ensemble modeling methods 240 and 340 using, for example, the Random Forest 242 and 342, the Linear Regression 244 and 344, the MaxENT 246 and 346, and the Suitability Models 248, to generate the output 280 and 380, including, for example, the species distribution maps 282 and 382, the probability scores/maps 284 and 384, the biodiversity indices 286 and 386, and the site suitability scores 288.

In some embodiments, as shown in FIGS. 3 and 4, the ensemble modeling methods 340 and 440, themselves with or without input from the users 10 and/or from the system administrators 20 (e.g., varying weights to increase and/or decrease emphasis or priority of data values, as described below) of the FishLAT system 100, formulate one or more sets of rules, shown generally at 360 and 460, used to generate their output 280, 380, and 480. In some embodiments, the rules 360 and 460 instruct the system to use habitat-specific estimates and predictions on, for example, infrastructure, artificial reefs, and lease blocks to predict species distribution and probability of presence of species within the marine habitat provided by the existing and/or proposed offshore infrastructure development and decommissioning projects. In one embodiment, the one or more sets of rules 360 and 460 may be stored in the data storage device 160 as the rules 176. Perceived benefits and advantages of the FishLAT system 100 and its ensemble modeling methods 240, 340, and 440 are seen to include, for example, its robustness to overfitting, its ability to efficiently handle large datasets with higher dimensionality, and its effective capturing of complex interactions among input features. Additionally, some perceived competitive advantages of the FishLAT system and method over conventional systems and approaches lie in its innovative use of forecast modeling and rules for marine spatial planning, enabling tailored, project-specific assessments to inform development and decommissioning decision-makers. These capabilities are seen to surpass those of open-source alternatives, providing a level of precision and functionality not otherwise available. For example, the FishLAT system 100 provides species richness prediction where the ML models 254, the ensemble modeling methods 240, 340, and 440, and rules 360 and 460 (stored as rules 176) predict a number of different marine species (e.g., fish, mammals, turtles, organisms, and other marine life) expected in one or more areas or sites of interest. The FishLAT system 100 generates predictions that are habitat-specific in that the system predicts and generates output illustrating the number of species at a given resolution (e.g., a reef site, a platform, or a lease block and environmental conditions thereof) with its use ML models, ML algorithms (e.g., ML models 254, Random Forest 242 and 342, Linear Regression 244 and 344), and rules 360 and 460 to estimate the number of different species expected based on the input features. The FishLAT system 100 also generates and provides a probability of presence estimate. For example, the ML models, ML algorithms (e.g., Random Forest 242 and 342, MaxENT 246 and 346), and rules 360 and 460 are applied to generate an estimate of the likelihood of specific species being present at a habitat. In some embodiments, predictions generated by the FishLAT system 100 are habitat-specific in that the system 100 generates a prediction of the number of species at a given resolution (e.g., a reef site, a platform, or a lease block and the environmental conditions thereof). In some embodiments, the generated prediction may impact the rule-based site suitability rating, ranking, and/or scoring in a number of ways depending on, for example, the context of the criteria for suitability. For example, if the FishLAT system 100 generates a prediction of a high likelihood of Lutjanus campechanus (i.e., a red snapper) presence due to, for example, proximity to reef structures and/or other environmental conditions (e.g., depth, substrate type, or the like), the site may be assigned a higher suitability rating, ranking, or score for commercial fisheries value, particularly in regions where this species is a targeted catch. Additionally, a site predicted to host greater species richness or biodiversity may be prioritized for conservation or habitat protection, especially if the site overlaps with other known valuable attributes such as, for example, ecological hotspots or migration corridors. As described herein, it is within the scope of the present disclosure for the rules-based suitability rating, ranking, and/or scoring to be provided by a relative value (e.g., “excellent,” “good,” “moderate,” and/or “poor”), an alphabetic values (e.g., “A” being a highest value to “Z” being a lowest value), a numeric value (e.g., values one to ten, one to one hundred, etc.), and/or another representation of an order of importance for objective comparison purposes.

As shown in FIGS. 2 to 4, the FishLAT system 100 generates output 280, 380, and 480 from its ensemble modeling methods and algorithms 240, 340, and 440 and rules 360 and 460, and evaluation of one or more areas or sites of interest. In some embodiments, the output 280, 380, and 480 may include the species distribution maps 282 and 382, the probability scores/maps 284 and 384, biodiversity indices 286 and 386, and site suitability scores 288 and 488. In some embodiments, the species distribution maps 282 and 382 include, for example, visual representations of the predicted presence of targeted species across one or more different sites of interest. In some embodiments, the probability scores/maps 284 and 384 include, for example, probability estimates and maps indicating the likelihood of the presence of specific species at one or more given locations. In some embodiments, the biodiversity indices 286 and 386 include, for example, calculated indices that provide a measure of an overall biodiversity, for example, the variety of marine life in a particular habitat or ecosystem about the areas or sites of interest. In some embodiments, the indices 286 and 386 assist in identifying biodiversity hotspots, for example, areas that contain a high level of marine species diversity, endemic species namely, marine species found at the site of interest and not found anywhere else, and/or a presence of threatened or endangered marine species. In some embodiments, the site suitability scores 288 and 488 may be used to, for example, evaluate the potential of the area or site of interest, by application of one or more of the aforementioned rules, for reef development and other offshore infrastructure projects by, for example, generating a prediction of a higher or more positive value of a reef site as compared to other sites and thereby supporting and/or encouraging site selection.

In some embodiments, the FishLAT system 100 uses a suitability model that combines ML techniques and domain-specific knowledge to evaluate, according to its rule-based suitability or acceptability thresholds, the potential of offshore sites as reef development sites. For example, and as described above, the FishLAT system 100 receives input features including, for example, physical characteristics of a site of interest including depth, substrate type and the like, biological data regarding the site including species presence, the biodiversity indices, and the like, as well as environmental conditions including water quality, temperature, and the like. The system processes these data inputs using structured ensemble modeling, algorithms, and rules to generate suitability scores 288 and 488, which scores or ranks potential reef sites according to, for example, their overall compatibility or acceptability, within defined thresholds, with reef development objectives. For example, in some embodiments, a higher rules-based suitability rating, ranking, and/or scoring may be achieved by sites that conform to rules, for example, that exhibit valuable physical parameters (e.g., a suitable depth, a stable substrate, and the like), and strong biological indicators (e.g., higher predicted presence of reef-associated species, elevated biodiversity indices, and the like). In some embodiments, a scoring algorithm (e.g., one of the ML algorithms 172) may also factor other rules such as, for example, are in proximity to existing reef structures, reduced risk of user conflict, or exhibit alignment/agreement with, for example, regulatory and/or conservation priorities, allowing for comparative decision-making across two or more candidate sites of interest. This modeling pipeline transforms multi-dimensional environmental datasets into quantitative outputs designed for real-world reef planning. Within the generation of the rules-based suitability scores 288 and 488 for sites by the scoring algorithm, the FishLAT system 100 may consider multiple criteria and may apply dynamic weights based on contextual priorities such as, for example, maximizing habitat value for commercial and/or recreational fisheries, minimizing user conflict with existing offshore infrastructure, or aligning with regional marine spatial planning and/or conservation objections defined by, for example, one or more users 10 and/or one or more system administrators 20 of the FishLAT system 100.

As should be appreciated, in some embodiments, processing within the ML scoring algorithm may be adjusted (e.g., manually by a user 10 or administrator 20 or automatically by the FishLAT app 124A, 154A, or 160A) by use of one or more weights to emphasize and/or deemphasize data and/or rules (e.g. the rules 176) to incorporate, for example, goals, priorities, and/or feedback from stakeholders and/or other users 10 of the system 100, and/or may be adjusted based on successive iterations within, for example, a recursive process of site evaluation where, for example, the ML models and/or rules act with limited or insufficient data, may iteratively learn how to achieve target objectives of the site evaluation. For example, in some embodiments, the FishLAT system 100 may leverage ML models and algorithms to learn by recognizing faults in previous predictions, patterns of data, and the like, to further develop the models and/or rules to optimize performance, resource utilization, cost of development or decommissioning projects, and/or to improve accuracies of inferences, decisions, and predictions over a wide range of environmental and ecological factors. In some embodiments, this method is seen to provide a degree of customizable, data-driven evaluation framework for assessing reef development potential across diverse regions and use cases. Unlike conventional manual assessment methods, the FishLAT system 100 automates, scales, and standardizes the reef site selection process, reducing subjectivity and enabling faster, more efficient, repeatable, and region-specific ecological evaluation. The system may generate outputs such as rules-based suitability ratings, rankings, or scoring of lists of sites, map-based reports, or exportable datasets (described herein) to assist stakeholders in decision-making regarding reef placement. For example, the FishLAT system 100 may estimate an ecological value of one or more sites of interest for potential development and/or reefing/decommissioning by analyzing multiple environmental and biological factors to generate the rules-based suitability ratings, rankings, or scoring considering, for example, maximizing habitat value for fisheries, minimizing user conflict, or aligning with and/or meeting or failing to meet, within defined thresholds, local, regional, or national planning goals, to aid decision-makers in selecting best sites for development and/or decommissioning. In some embodiments, the FishLAT system 100 generates a ranked list of sites based on their rules-based suitability rating, ranking, and/or scoring, for example, their ecological value and/or relatively potential of a given offshore site to meet or exceed specified environmental or other objectives for development and/or decommissioning. It should be appreciated that the definition of “suitability” and/or “acceptability” is intentionally flexible to allow for dynamic weighting of criteria based on, for example, an intended use case. For example, in some embodiments, a conservation-focused site evaluation may prioritize, for example, rules for biodiversity and species presence of sites, while a recreational fishing-focused site evaluation may prioritize, for example, rules for accessibility and fishing effort forecasts of sites under evaluation. In some embodiments, the FishLAT system 100 generates detailed reports for one or more areas or sites of interest for potential development and/or reefing (e.g., decommissioning) where the detailed reports include, for example, predictions and insights derived by the FishLAT system 100 from its ensemble modeling methods 240, 340, and 440 (e.g., ML models and ML algorithms such as ML models 254, Random Forest 242 and 342, Linear Regression 244 and 344), and rules 360 and 460 defining the suitability of the sites in meeting or failing to meet, within defined thresholds, regulatory and/or industry criteria.

In some embodiment, the FishLAT system 100 selects and applies rules-based criteria for site suitability prediction that are aligned with multiple stakeholder/user-defined performance metrics, including environmental and biological factors, which can be customized for project-specific assessments. In some embodiments, key regulatory, stockholder/user, and/or industry rules and/or criteria may include, for example:

(1) Site Ecology: The FishLAT system 100 may generate predictions of biodiversity levels at a given reef site to, for example, help determine an ecological value and species richness expected at a given location, using environmental variables and species distribution models. This factor or rule is seen to allow stakeholders and other users to identify reef placement locations that best support, within defined thresholds, local, regional, national, and/or international biodiversity goals and align with conservation, ecologically responsible fishery management, and/or other priorities.

(2) Probability of Presence: The FishLAT system 100 may generate predictions of a likelihood of encountering specific target species based on historical records, habitat models, and/or environmental correlations. This factor or rule supports more targeted reef deployments by prioritizing habitat for species of interest, aligning with fisheries management and/or conservation strategies.

(3) Accessibility: The FishLAT system 100 may evaluate access constraints and logistical considerations, including proximity to ports or user communities, based on geospatial data. Applying weights to this factor or rules within the generation of predictions is seen to ensure sites are practical and feasible for recreational, commercial, and/or scientific use, especially in areas where user accessibility is seen to drive economic and/or social outcomes.

(4) Predicted Fishing Effort: The FishLAT system 100 may model post-deployment (e.g., after development and/or reefing/decommissioning) fishing activity at a site, based on historical fishing effort data (e.g., time spent fishing at various locations) and expected reef attractiveness, which can be important for balancing ecological health with economic use. This information supports ecosystem-based management by forecasting potential stakeholder/user pressure and informing sustainable fishing practices and overall fishery management. Incorporating this factor or rule within site evaluation can help avoid, or at least minimize, overfishing risks and promote more ecologically sustainable management.

(5) Regulatory Compliance: The FishLAT system 100 may generate predictions that assist stakeholders and other users demonstrate compliance with legal and/or environmental compliance of one or more specified sites.

By applying a weighted prioritization scheme employing, for example, the key criteria or rules outlined above, the FishLAT system 100 enables customized, stakeholder/user-specific reef site evaluations and recommendations. For example, a conservation-focused development and/or reefing/decommissioning project might prioritize biodiversity and species presence, while a recreational fishing initiative might prioritize accessibility and fishing effort forecasts. This flexibility within its criteria or rules is implemented via a structured configuration interface and modular backend architecture that adapts model and algorithm outputs to user needs. The FishLAT system 100 thereby provides technically concrete, repeatable, and application-specific decision-support outputs that can be directly integrated into environmental review, permitting, and/or spatial planning workflows.

As noted above, in some embodiments, one or more users 10 of the FishLAT system 100 may operate the FishLAT APP 124A, 154A, or 160A to initiate processing to generate and exhibit the generated output 280, 380, and 480 on, for example, the Interactive Dashboard 290, 390, and 490, which may include the one or more of the GUIs 1000 and/or the reports 2000 (as described in detail below) exhibited on the display device 142 of the user device 120 operated by the user 10 or output by the printer 144. In some embodiments, the users 10 may operate the GUIs 1000 to review data collected by the FishLAT system 100, review initial predictions made by the system 100, to input new data, and to initiate one or more exploration, development, and/or decommissioning scenarios 166 to generate predictions of, for example, impacts on biodiversity and the probability of presence of certain, targeted species at one or more specific areas or sites of interest for development and/or decommissioning, in response to the new data. In some embodiments, the interactive dashboard 290, 390, and 490 may be used (e.g., by operation of functionality presented on one or more of the GUIs 1000) to order reports (e.g., the reports 2000) detailing the assessments, evaluations, and/or rules-based suitability rating, rankings, and/or scoring generated by the FishLAT system 100 for one or more of the areas or sites of interest. In some embodiments, the assessments, evaluations, and/or rankings consider regulatory criteria (e.g., legal and environmental), and/or stakeholder/user and/or industry criteria (e.g., biodiversity, species richness, conservation, fisheries management, fishing effort, and the like) within the areas or sites of interest and conformity thereto, when generating predictions and providing the generated output.

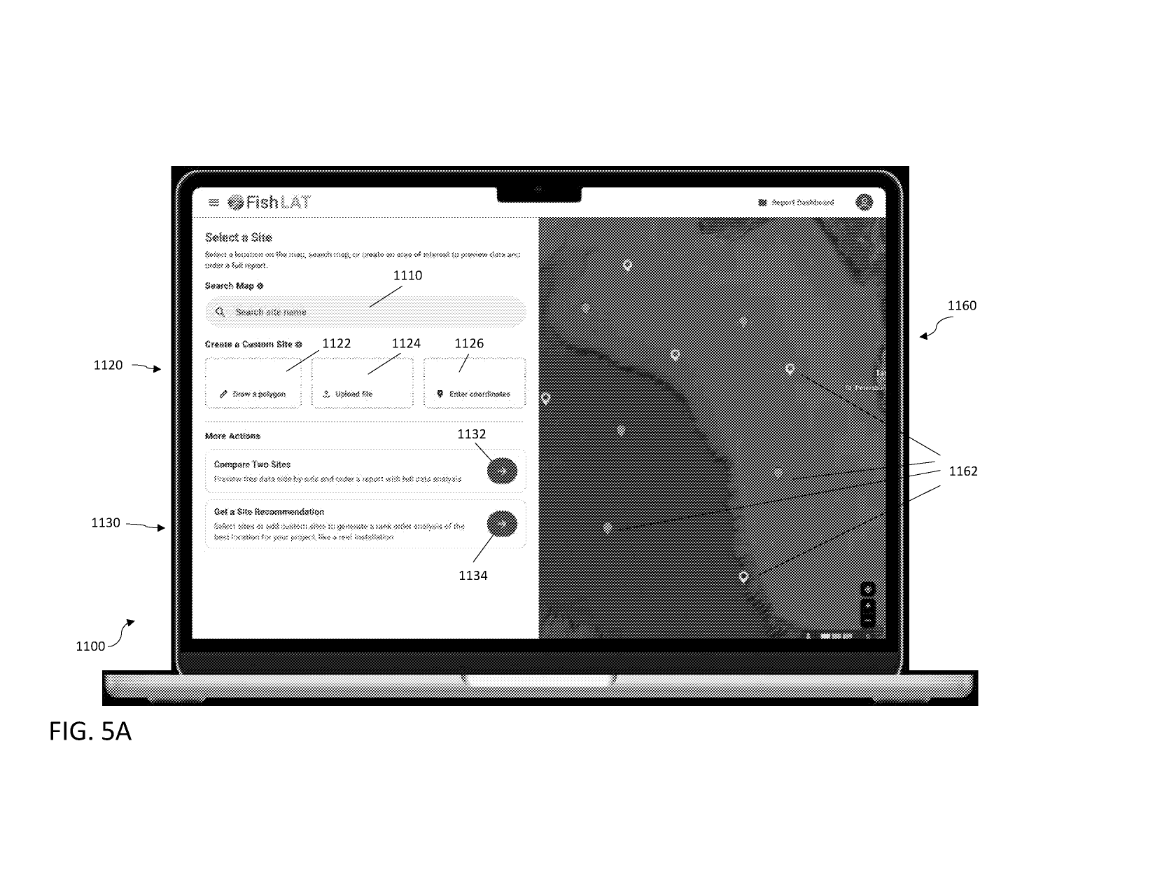

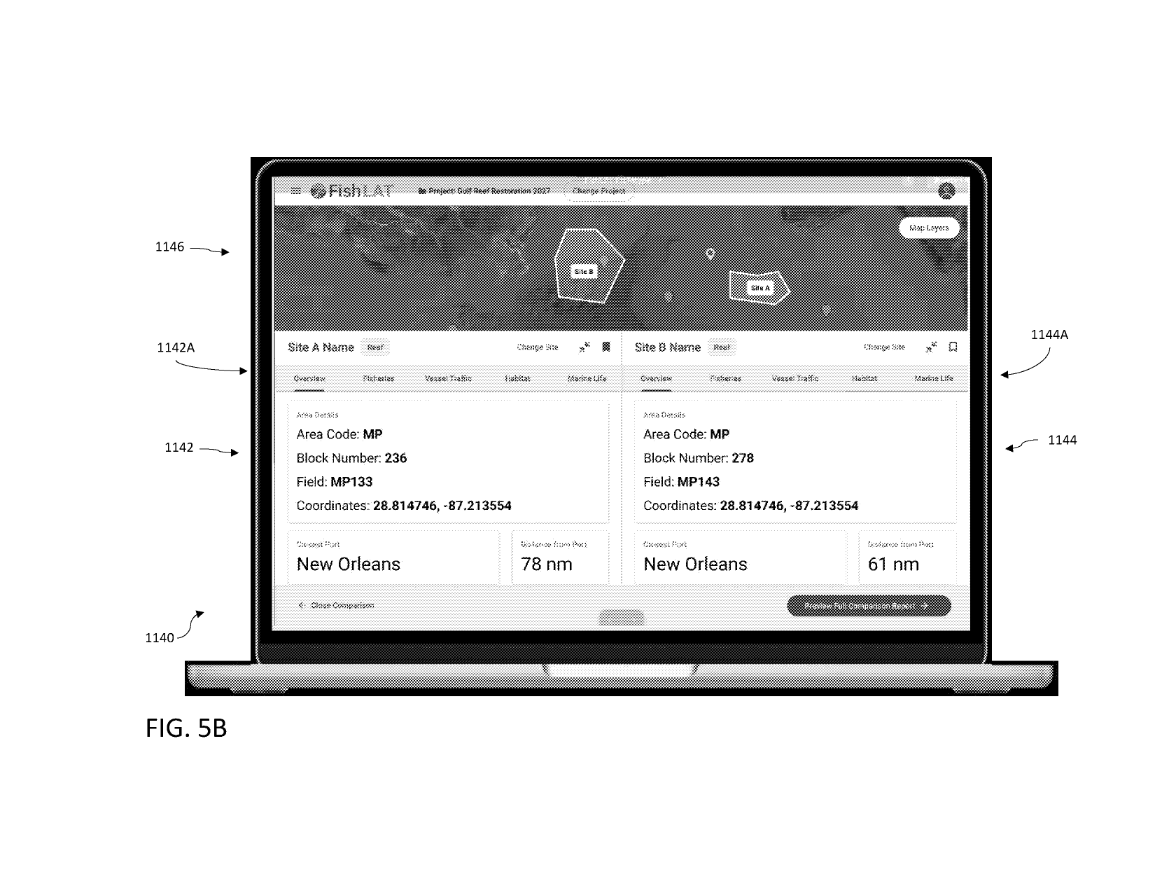

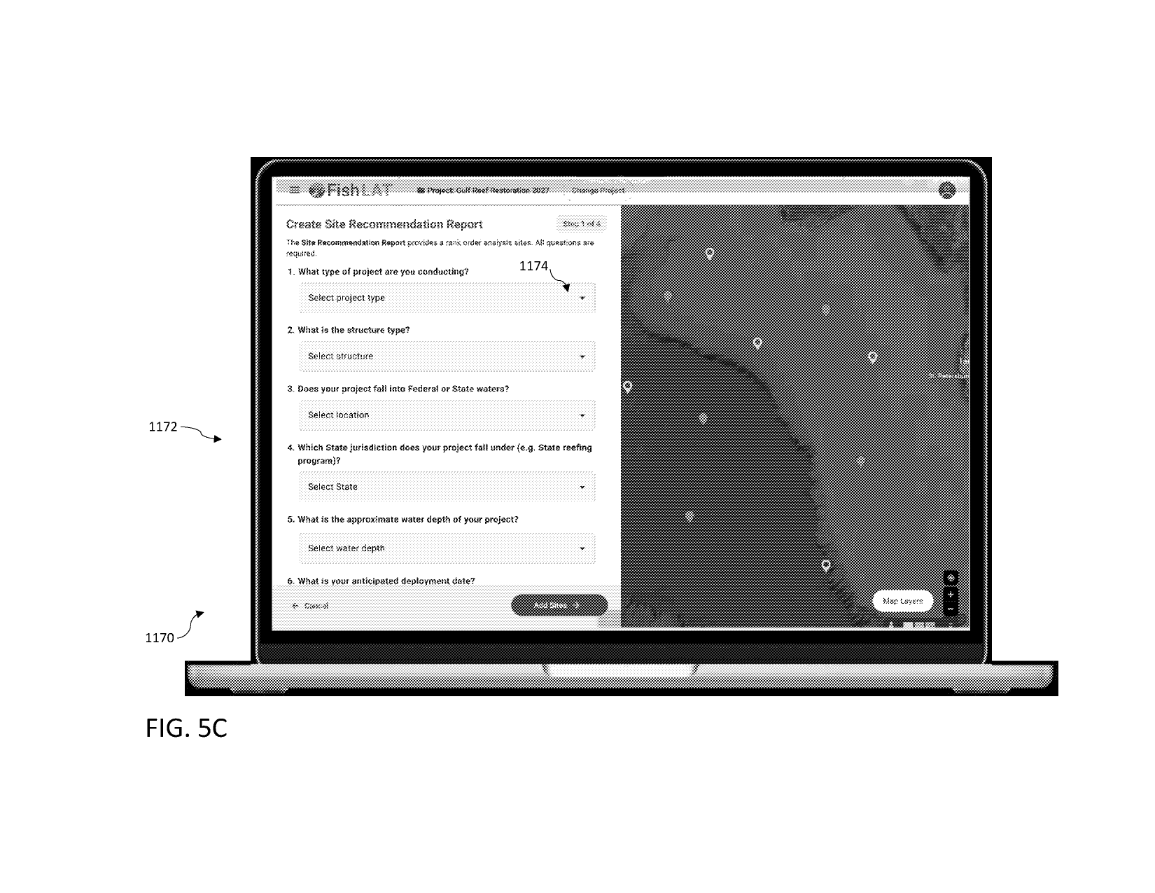

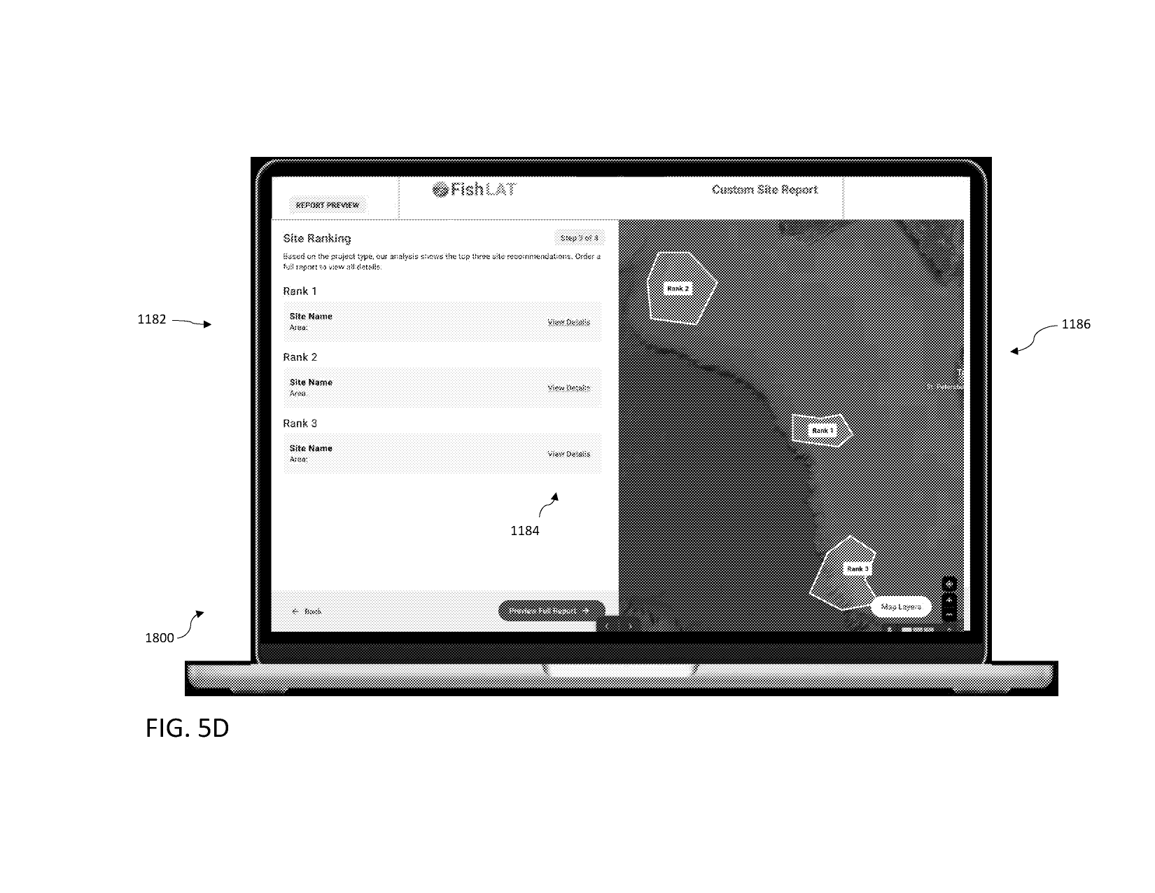

Example GUIs 1000 and reports 2000 depicting, for example, portions of the outputs 280, 380, and 480 and the Interactive Dashboard 290, 390, 490 of the FishLAT system 100, are shown in FIGS. 5A to 12 and 13 to 16, respectively, and are described as follows.

FIG. 5A depicts a Site Selection GUI 1100 of the Interactive Dashboard 290, 390, 490 and the GUIs 1000 that is exhibited by the FishLAT app 124A, 154A, or 160A to one of the users 10 of the FishLAT system 100 on the display device 142 of the user device 120 operated by the user. In some embodiments, the Site Selection GUI 1100 is exhibited to one of the users 10 after an initial sign-on to the FishLAT system 100, for example, after the user 10 enters his/her login credentials and is verified as an authorized user of the system 100. In one embodiment, the Site Selection GUI 1100 includes a Site Search field 1110 where an existing one of the sites or areas of interest within the FishLAT system 100 may be specified (e.g., by input of a site name entered into the Site Search field 1110) to initiate a search and retrieval of a corresponding one of the plurality of site profiles 162 within the data storage device 160. In one embodiment, the Site Selection GUI 1100 includes a region, shown generally at 1160, that exhibits sites or areas of interest 1162 within proximity to a marine location under analysis within the system 100 such as, for example, a portion of the Gulf of Mexico exhibited in FIG. 5A. In some embodiments, selecting one of the exhibited sites or areas of interest 1162 provides access to a corresponding one of the site profiles 162 for the selected site. In some embodiments, the Site Selection GUI 1100 also includes a region, shown generally at 1120, where a user 10 of the FishLAT system 100 may invoke functionality of the system 100 to create a new Site for analysis by the system 100.

In one embodiment, the region 1120 includes a plurality of controls to allow creation of the new Site of interest. For example, in one embodiment, the region 1120 of the Site Selection GUI 1100 includes a Draw a Polygon control 1122, an Upload File control 1124, and an Enter Coordinates control 1126. In one embodiment, selecting one of the controls 1122, 1124, and 1126, invokes additional functionality of the FishLAT system 100 that may be utilized to define the new Site by, for example, drawing a polygonal shape to define a location within the region 1160 (selecting the Draw a Polygon control 1122), uploading a file having information to define the new Site within the region 1160 (selecting the Upload File control 1124), and entering geo-location coordinates of, for example, latitude and longitude within the region 1160 (selecting the Enter Coordinates control 1126). In some embodiment, the Site Selection GUI 1100 also includes a More Actions region, shown generally at 1130, where further additional functionality of the FishLAT system 100 may be invoked. For example, as depicted in FIG. 5A, the More Actions region 1130 includes controls 1132 and 1134 for invoking functionality to compare, e.g., in a side-by-side manner as depicted on a Site Comparison GUI 1140 of FIG. 5B, two existing ones of the sites or areas of interest 1162 and the data thereof within corresponding site profiles 162 for specified sites 1162 (e.g., by selecting the control 1132) or for invoking functionality to generate an on-demand, rule-based rank order analysis (e.g., suitability rankings) among specified sites 1162 (e.g., entered by name or selected on the region 1160 by selecting the control 1134) as depicted on a Create Site Recommendation GUI 1170 and a Site Ranking Report GUI 1180 in FIGS. 5C and 5D, respectively, described below.

As shown in FIG. 5B, when the control 1132 of the Site Selection GUI 1100 (FIG. 5A) is selected, the FishLAT app 124A, 154A, or 160A invokes functionality to exhibit the Site Comparison GUI 1140 of FIG. 5B to exhibit two existing sites within a region 1142 (e.g., for a first site labeled “Site A”) and a region 1144 (e.g., for a second site labeled “Site B”) of the Site Comparison GUI 1140. In some embodiments, the regions 1142 and 1144 include navigation elements 1142A and 1144A, respectively, that when selected exhibit further information regarding the specified site including, for example, an Overview tab, a Fisheries tab, a Vessels Traffic tab, a Habitat tab, and a Marine Life tab, described in detail below. The Site Comparison GUI 1140 also may include a region, shown generally at 1146, that exhibits marine locations for the sites being compared demonstrating, for example, their proximity to each other. Referring again to FIG. 5A, when the control 1134 of the Site Selection GUI 1100 is selected, the FishLAT app 124A, 154A, or 160A invokes functionality to exhibit the Create Site Recommendation GUI 1170, as shown in FIG. 5C. The Create Site Recommendation GUI 1170 presents a plurality of questions, in one embodiment exhibited within an ordered list shown generally at 1172, to guide the user 10 through a process to define two or more existing sites for which the FishLAT system 100 conducts an on-demand, rule-based rank order analysis and generates the Site Ranking Report GUI 1180 including a rank region 1182 presenting the generated ranking, as shown on FIG. 5D. In some embodiments, the rank region 1182 may include navigation controls, shown generally at 1184, that when selected exhibit additional details for one or more of the sites presented within the rank region 1182. In some embodiments, the Site Ranking Report GUI 1180 may include a region 1186 that provides a visual representation exhibiting marine locations of the sites being ranked demonstrating, for example, their proximity to each other. Referring again to FIG. 5C, in some embodiments of the Create Site Recommendation GUI 1170, within the ordered list of questions 1172 each question presented may include a dropdown menu control element, shown generally at 1174. When selected for the dropdown control 1172 for a specific question presented, the FishLAT app 124A, 154A, or 160A invokes functionality to exhibit a predefined list of possible answers to the specific question to assist the user 10 input an acceptable response. In some embodiments, the list of possible answers may be a static list (e.g., providing a limited number of acceptable responses) and/or may be dynamically generated by the FishLAT app 124A, 154A, or 160A, e.g., based upon data values already existing with the FishLAT system 100.

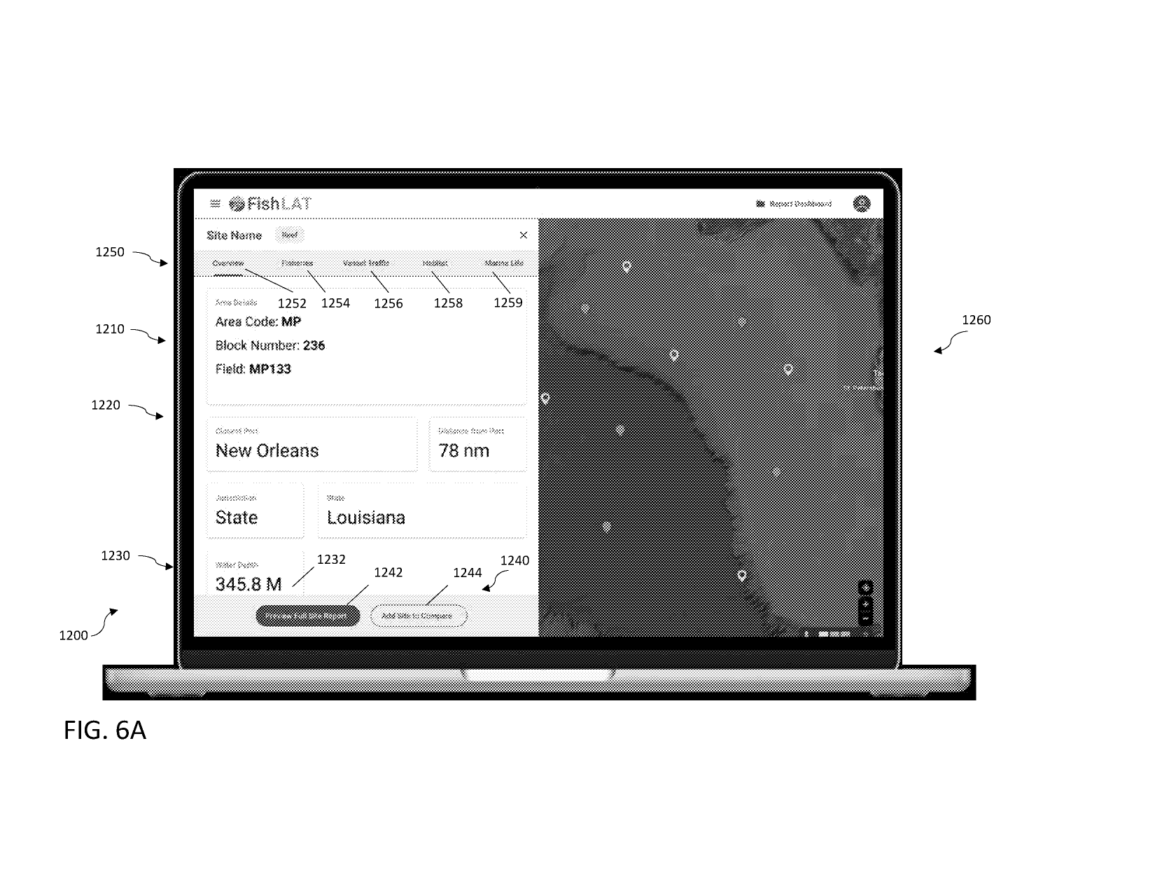

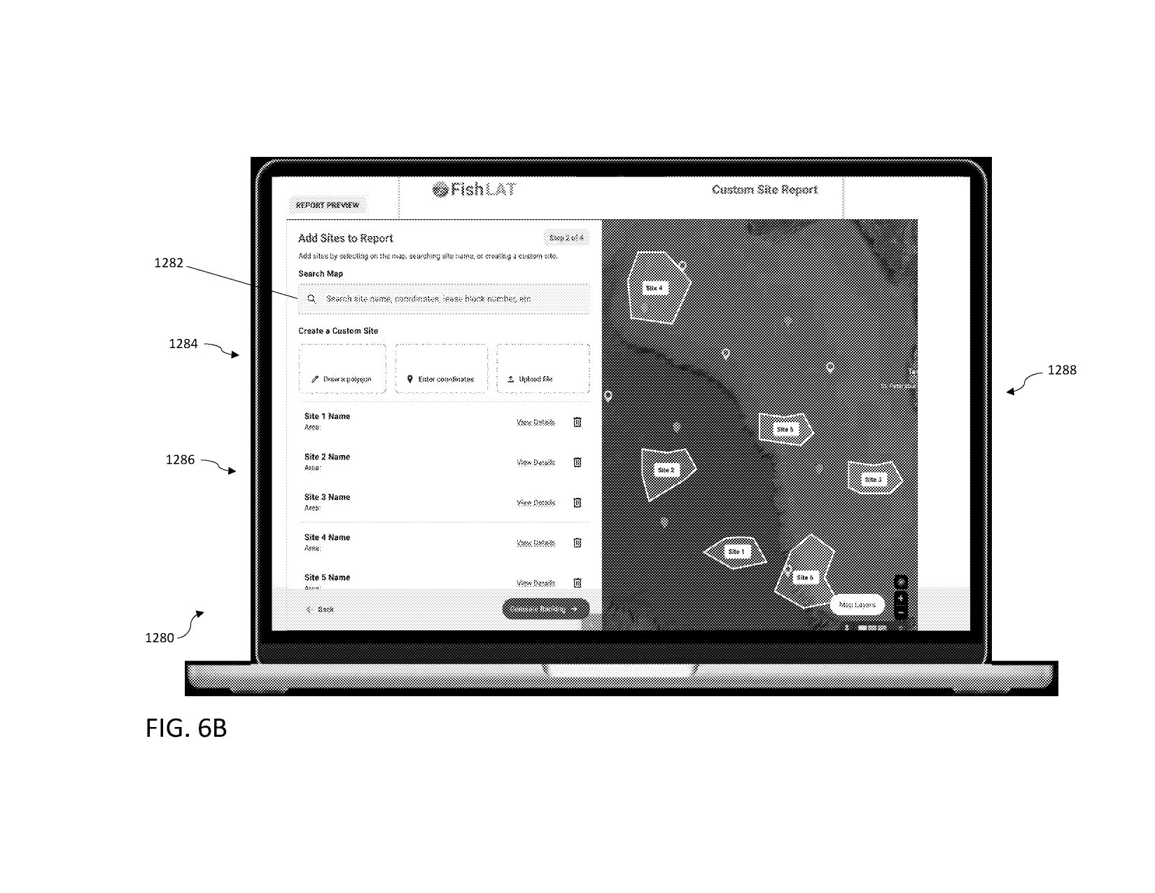

As depicted in FIG. 6A, in one embodiment, when one of the sites or areas of interest 1162 is specified on the Site Selection GUI 1100 (FIG. 5A), e.g., by entering the site name in the Site Search field 1110 or selecting the site or area of interest 1162 within the region 1160, the FishLAT app 124A, 154A, or 160A retrieves the corresponding one of the site profiles 162 within the data storage device 160 for the specified site and invokes an Overview GUI 1200 of the Interactive Dashboard 290, 390, 490. As shown in FIG. 6A, the Overview GUI 1200 exhibits the information for the specified site stored within the site profile 162. In one embodiment, the information exhibited within the Overview GUI 1200 may include, for example, details of the area surrounding the specified site within an Area Details region, shown generally at 1210, information regarding a closest port to the specified site within a Port Details region, shown generally at 1220, as well as marine data for the specified site in a Marine Data region, shown generally at 1230. As also shown in FIG. 6A, the Overview GUI 1200 includes a region, shown generally at 1260, that exhibits the sites or areas of interest 1162 within proximity to a marine location under analysis within the system 100, similar to region 1160 of the Site Selection GUI 1100 (FIG. 5A). In one embodiment, the Marine Data region 1230 of the Overview GUI 1200 may include physical characteristics of specified site, for example, depth of the water at the site as shown in a Water Depth field 1232.

In one embodiment, the Overview GUI 1200 also includes an Additional Actions region, shown generally at 1240, where further functionality of the FishLAT system 100 may be invoked. For example, as depicted in FIG. 6A, the Additional Actions region 1240 includes controls 1242 and 1244 for invoking functionality to preview a report for the specified site (e.g., by selecting a Preview Full Site Report control 1242) or for invoking functionality to add the specified site to a list of sites for comparison to other specified sites 1162 (e.g., by selecting a Add Site to Compare control 1244). For example, when selecting the Add Site to Compare control 1244, the FishLAT app 124A, 154A, or 160A exhibits an Add Sites GUI 1280 depicted in FIG. 6B including options to add one or more existing or newly created sites 1162 for comparison to the site currently presented on the Overview GUI 1200 (FIG. 6A). As shown in FIG. 6B, in some embodiments, the Add Sites GUI 1280 may include various options for selecting sites 1162 to include in the comparison, for example, by inputting a site name, coordinates, or other identifying names or numbers within a search field 1282, by creating a new site 1162 with navigation tools, shown generally at 1284, by selecting a site on a list of site names shown generally at 1286, and/or selecting a site 1162 within a region 1288 exhibited on the Add Sites GUI 1280 identifying one or more existing sites at marine locations in proximity to the site 1162 currently presented on the Overview GUI 1200 (FIG. 6A). Referring again to FIG. 6A, in some embodiments, the Overview GUI 1200 includes a plurality of navigation elements, shown generally at 1250, where a user/operator 10 may select options for viewing additional details of the specified site 1162 and information thereof stored within the data storage device 160. In one embodiment, the navigation elements 1250 include, for example, an Overview tab 1252, a Fisheries tab 1254, a Vessels Traffic tab 1256, a Habitat tab 1258, and a Marine Life tab 1259. As described below, when one of the plurality of navigation elements 1250 is selected, the FishLAT app 124A, 154A, or 160A invokes one of the GUIs 1000 to exhibit corresponding information regarding a specified one of the sites 1162. In one embodiment, access to the navigation elements 1250 may be disabled depending upon a status of the user 10, for example, as a subscriber versus a non-subscriber to the FishLAT system 100. As shown in FIG. 6A, in some embodiments, when the Overview tab 1252 is selected, the FishLAT app 124A, 154A, or 160A invokes and exhibits the Overview GUI 1200 of FIG. 6A.

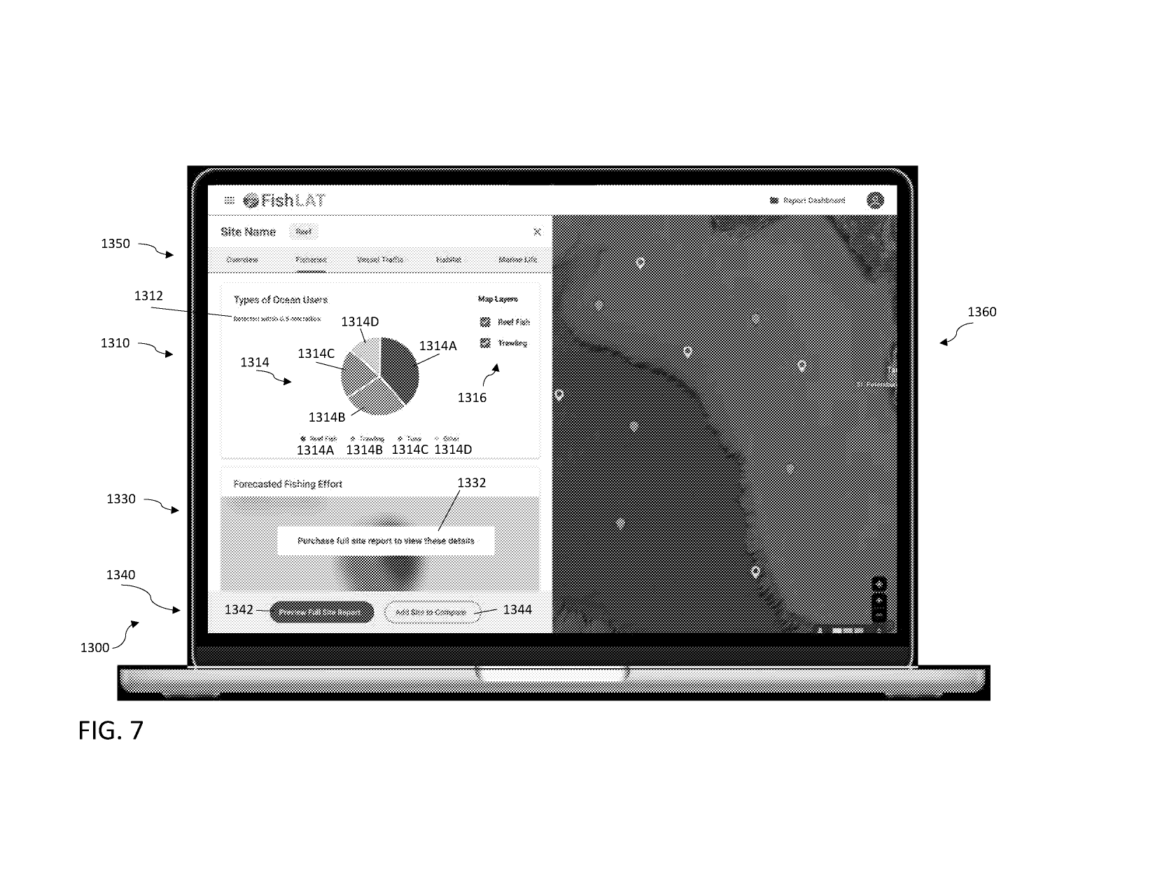

As shown in FIG. 7, when the Fisheries tab 1254 is selected on the Overview GUI 1200 (FIG. 6A), the FishLAT app 124A, 154A, or 160A invokes and exhibits a Fisheries GUI 1300 of the Interactive Dashboard 290, 390, 490. The Fisheries GUI 1300 exhibits fisheries-related information within a region, shown generally at 1310, from the corresponding one of the site profiles 162 within the data storage device 160 for the specified site 1162. In one embodiment, the FishLAT app 124A, 154A, or 160A exhibits the fisheries-related information within a user-defined or system defined radius of the specified site 1162. For example, as shown in FIG. 7, the fisheries-related information within a radius of, for example, about 0.5 nautical miles (nm) of the specified site 1162 is exhibited. In one embodiment, a range field 1312 exhibits a current value of the specified radius. As shown in FIG. 7, the fisheries-related information includes types of ocean users active within the specified radius exhibited generally at 1314. In some embodiments, the types of ocean users include one or more stakeholders of the FishLAT system 100. In one embodiment, the types of ocean users 1314 are presented in, for example, a pie chart and a legend identifying the ocean users 1314 as, for example, Reef Fish users 1314A, Trawling users 1314B, Tuna 1314C, and Other users 1314D.

As also shown in FIG. 7, the Fisheries GUI 1300 includes a region, shown generally at 1360, that exhibits the sites or areas of interest 1162 within proximity to a marine location under analysis within the system 100, similar to the region 1160 of the Site Selection GUI 1100 (FIG. 5A) and the region 1260 of the Overview GUI 1200 (FIG. 6A). As shown in FIG. 7, in some embodiments, the region 1310 may include control elements, shown generally at 1316, that provide options to supplement the region 1360 to depict a fishing effort (e.g., reef fishing labeled “Reef Fish” and/or fishing by trawling labeled “Trawling”) at sites 1162 illustrated in the region 1360. Additionally, the Fisheries GUI 1300 includes a plurality of navigation elements, shown generally at 1350, similar to the navigation elements 1250 of the Overview GUI 1200 of FIG. 6A, where the user/operator 10 may select options for viewing additional details of the specified site 1162 and information thereof stored within the data storage device 160. In one embodiment, the Fisheries GUI 1300 includes a region, labeled “Forecaster Fishing Effort” and shown generally at 1330, to present a preview of information related to a predicted or forecasted level of fishing activity at and/or in proximity to (e.g., within the specified radius) the specified one of the sites or areas of interest 1162. In one embodiment, as shown in FIG. 7, depending on a status of the user 10 (e.g., subscriber versus non-subscriber) the preview of information may be obfuscated and a banner message 1332 is exhibited to the user 10 indicating that the information is available once the user 10 purchases a report or otherwise subscribes to the FishLAT system 100. In one embodiment, the Fisheries GUI 1300 also includes an Additional Actions region, shown generally at 1340, where further functionality of the FishLAT system 100 may be invoked. For example, as depicted in FIG. 7, the Additional Actions region 1340 includes controls 1342 and 1344 for invoking functionality to preview a report for the specified site (e.g., by selecting a Preview Full Site Report control 1342) or for invoking functionality to add the specified site to a list of sites for comparison to other specified sites 1162 (e.g., by selecting a Add Site to Compare control 1344). In some embodiments, selection of the Add Site to Compare control 1344, instructs the FishLAT app 124A, 154A, or 160A to invoke and exhibit the Add Sites GUI 1280 of FIG. 6B to add one or more additional sites 1162 to the information provided on the Fisheries GUI 1300.

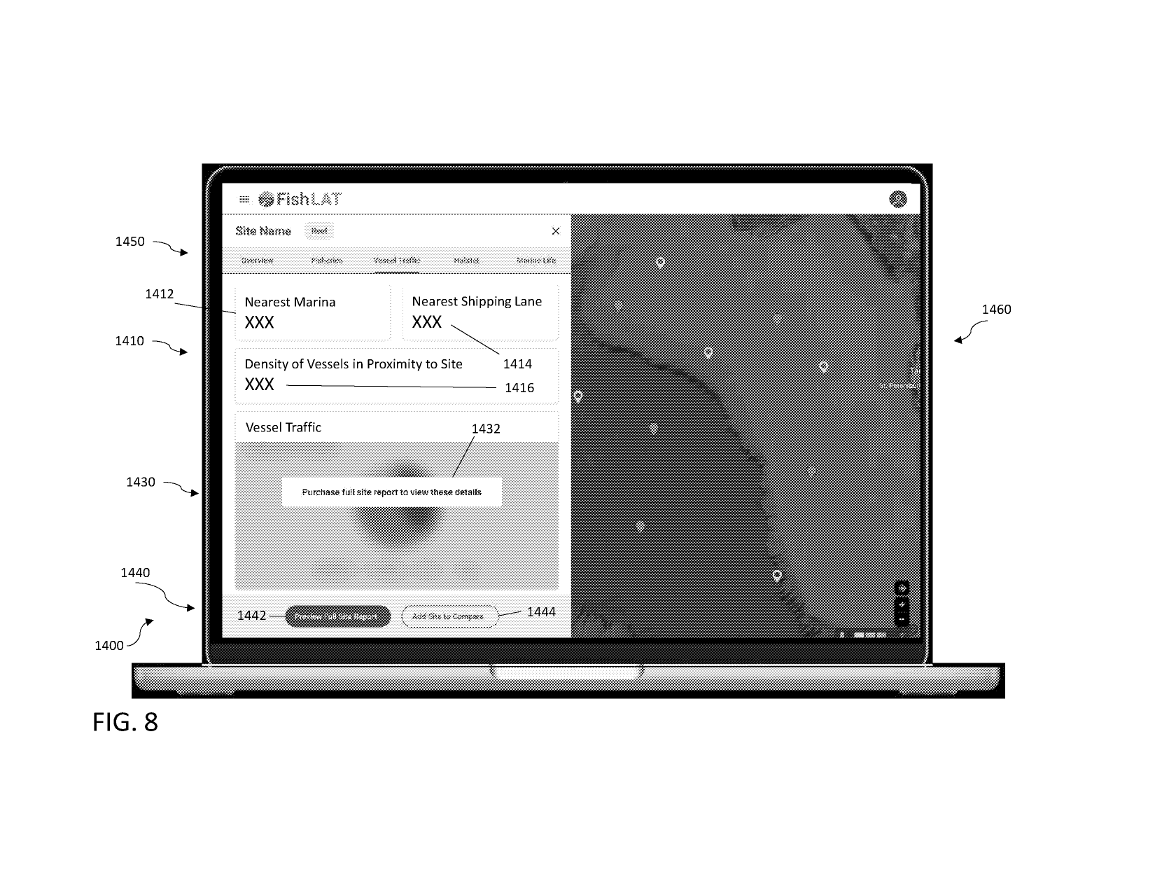

As shown in FIG. 8, when the Vessel Traffic tab 1256 is selected on the Overview GUI 1200 (FIG. 6A) or the Fisheries GUI 1300 (FIG. 7), the FishLAT app 124A, 154A, or 160A invokes and exhibits a Vessel Traffic GUI 1400 of the Interactive Dashboard 290, 390, 490. The Vessel Traffic GUI 1400 exhibits vessel traffic-related information within a region, shown generally at 1410, such as in proximity to a nearest marina as shown in a field 1412 labeled “Nearest Marina,” whose value is presented in, for example, nautical miles, in proximity to a nearest shipping lane as shown in a field 1414 labeled “Nearest Shipping Lane,” whose value is presented in, for example, nautical miles, and density estimates of vessels (i.e., long line fisheries, trawl fisheries, leisure vessels, etc.), as shown in a field 1416 labeled “Density of Vessels in Proximity to Site,” that are in proximity to the specified site 1162. In some embodiments, a density of vessels is a value representing a number of vessels within a predefined radius (e.g., 0.5 nm) from the specified site 1162. The value of the density of vessels is seen to be valuable because it provides a proxy for the fishing effort and activity in the area of the specified site 1162. For example, if evaluating one or more potential reefing sites, a higher vessel density about one site would indicate an area where commercial and/or recreational fishers are active, indicating a preference for the site. In this way, the density of vessels value provides a metric that helps identify sites that could maximize benefits to the fishing community while also providing useful context for considerations such as navigational safety and resource management. In one embodiment, the FishLAT app 124A, 154A, or 160A exhibits the vessel traffic-related information within a user-defined or system defined radius of the specified site 1162. For example, as shown in FIG. 8, the vessel traffic-related information, like the density of vessels, may be presented within a radius of, for example, about 0.5 nm about the specified site 1162. In some embodiments, the vessel traffic-related information may include types of marine vessels active within the specified radius. In some embodiments, the types of marine vessels may include, for example, trawling shrimp boats, as well as commercial, charter, and private recreational fisheries targeting reef fish, such as red snapper, as well as trophy fishes, such as tunas. Other vessels detected include pleasure vessels, typically yachts or sailboats registered to private owners or charters. In one embodiment, the FishLAT system 100 quantifies vessel activity using Automatic Identification System (AIS) and Vessel Monitoring System (VMS) data, which systems monitor and transmit information on, for example, vessel characteristics, current location, and vessel movement over time within, for example, U.S. and international waters. This data is quantified at, for example, lease block and site-specific levels within the FishLAT system’s models. In one embodiment, the analyses presented in the Vessel Traffic GUI 1400 adhere to the Department of Commerce Information Technology Privacy Policy, 16 U.S.C. 1881a, and National Marine Fisheries Service policy.

As also shown in FIG. 8, the Vessel Traffic GUI 1400 includes a region, shown generally at 1460, that exhibits the sites or areas of interest 1162 within proximity to a marine location under analysis within the system 100, similar to the region 1160 of the Site Selection GUI 1100 (FIG. 5A), the region 1260 of the Overview GUI 1200 (FIG. 6A), and the region 1360 of the Fisheries GUI 1300 (FIG. 7). Additionally, the Vessel Traffic GUI 1400 includes a plurality of navigation elements, shown generally at 1450, similar to the navigation elements 1250 of the Overview GUI 1200 of FIG. 6A, where the user/operator 10 may select options for viewing additional details of the specified site 1162 and information thereof stored within the data storage device 160. In one embodiment, the Vessel Traffic GUI 1400 includes a region, labeled “Vessel Traffic” and shown generally at 1430, to present a preview of information related to a predicted or forecasted level of vessel activity at and/or in proximity to (e.g., within the specified radius) the specified one of the sites or areas of interest 1162. In one embodiment, as shown in FIG. 8, depending on a status of the user 10 (e.g., subscriber versus non-subscriber) the preview of information may be obfuscated and a banner message 1432 is exhibited to the user 10 indicating that the information is available once the user 10 purchases a report or otherwise subscribes to the FishLAT system 100. In one embodiment, the Vessel Traffic GUI 1400 also includes an Additional Actions region, shown generally at 1440, where further functionality of the FishLAT system 100 may be invoked. For example, as depicted in FIG. 8, the Additional Actions region 1440 includes controls 1442 and 1444 for invoking functionality to preview a report for the specified site (e.g., by selecting a Preview Full Site Report control 1442) or for invoking functionality to add the specified site to a list of sites for comparison to other specified sites 1162 (e.g., by selecting a Add Site to Compare control 1444). As noted above, in some embodiments, selection of the Add Site to Compare control 1444, instructs the FishLAT app 124A, 154A, or 160A to invoke and exhibit the Add Sites GUI 1280 of FIG. 6B to add one or more additional sites 1162 to the information provided on the Vessel Traffic GUI 1400.

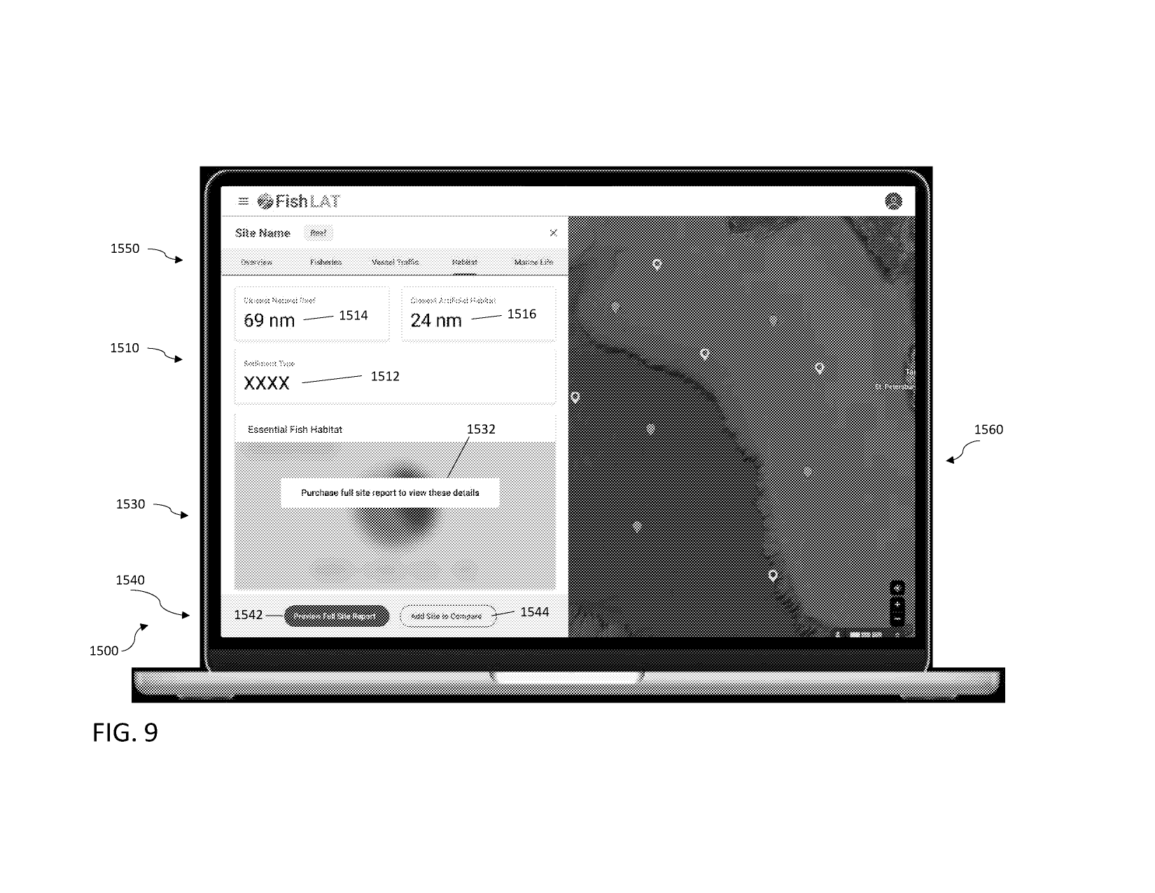

As shown in FIG. 9, when the Habitat tab 1258 is selected on the Overview GUI 1200 (FIG. 6A), the Fisheries GUI 1300 (FIG. 7), or the Vessel Traffic GUI 1400 (FIG. 8), the FishLAT app 124A, 154A, or 160A invokes and exhibits a Habitat GUI 1500 of the Interactive Dashboard 290, 390, 490. The Habitat GUI 1500 exhibits habitat-related information within a region, shown generally at 1510, from the corresponding one of the plurality of site profiles 162 within the data storage device 160 for the specified site 1162. In one embodiment, the FishLAT app 124A, 154A, or 160A exhibits the habitat-related information within the user-defined or system defined radius of the specified site 1162. As shown in FIG. 9, the habitat-related information includes marine data and other habitat information regarding the specified site with the region 1510. In one embodiment, the habitat-related information may include, for example, a type of sediment found at the specified site 1162 presented in, for example, a Sediment Type field 1512, a distance to a closest natural reef within a Closest Natural Reef field 1514, and a distance to a closest artificial habitat within a Closest Artificial Habitat field 1516.

As also shown in FIG. 9, the Habitat GUI 1500 includes a region, shown generally at 1560, that exhibits the sites or areas of interest 1162 within proximity to a marine location under analysis within the system 100 (e.g., the specified site), similar to the region 1160 of the Site Selection GUI 1100 (FIG. 5A), the region 1260 of the Overview GUI 1200 (FIG. 6A), the region 1360 of the Fisheries GUI 1300 (FIG. 7), and the region 1460 of the Vessel Traffic GUI 1400 (FIG. 8). Additionally, the Habitat GUI 1500 includes a plurality of navigation elements, shown generally at 1550, similar to the navigation elements 1250 of the Overview GUI 1200 of FIG. 6A, the navigation elements 1350 of the Fisheries GUI 1300 of FIG. 7, and the navigation elements 1450 of the Vessel Traffic GUI 1400 of FIG. 8, where the user/operator 10 may select options for viewing additional details of the specified site 1162 and information thereof stored within the data storage device 160. In one embodiment, the Habitat GUI 1500 includes a region, labeled “Essential Fish Habitat” and shown generally at 1530, to present a preview of information related to a selected marine area’s habitat characteristics, regulatory protections, and species-specific data. In some embodiments, the Habitat GUI 1500 dynamically updates as users navigate different locations at and/or in proximity to (e.g., within the specified radius of) the specified one of the sites or areas of interest 1162, exhibiting relevant metrics such as, for example, water quality, sediment type, and habitat suitability for essential species. This feature is seen to enable stakeholders and other users 10 to assess habitat quality and identify potential impacts of proposed activities within designated essential fish habitats, and thus is seen to provide a valuable tool for fisheries management and environmental assessments. In one embodiment, as shown in FIG. 9, depending on a status of the user 10 (e.g., subscriber versus non-subscriber) the preview of information may be obfuscated and a banner message 1532 is exhibited to the user 10 indicating that the information is available once the user 10 purchases a report or otherwise subscribes to the FishLAT system 100. In one embodiment, the Habitat GUI 1500 also includes an Additional Actions region, shown generally at 1540, where further functionality of the FishLAT system 100 may be invoked. For example, as depicted in FIG. 9, the Additional Actions region 1540 includes controls 1542 and 1544 for invoking functionality to preview a report for the specified site (e.g., by selecting a Preview Full Site Report control 1542) or for invoking functionality to add the specified site to a list of sites for comparison to other specified sites 1162 (e.g., by selecting a Add Site to Compare control 1544). Once again, in some embodiments, selection of the Add Site to Compare control 1544, instructs the FishLAT app 124A, 154A, or 160A to invoke and exhibit the Add Sites GUI 1280 of FIG. 6B to add one or more additional sites 1162 to the information provided on the Habitat GUI 1500.

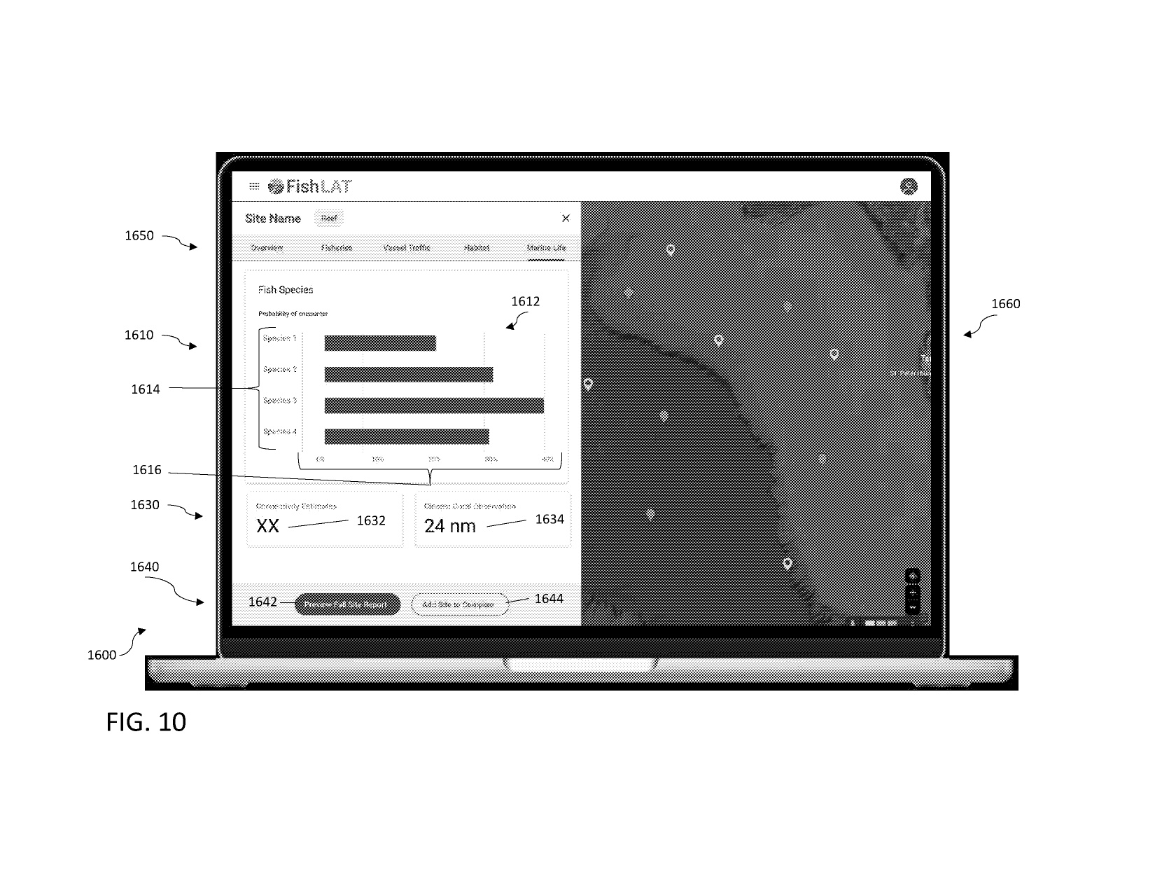

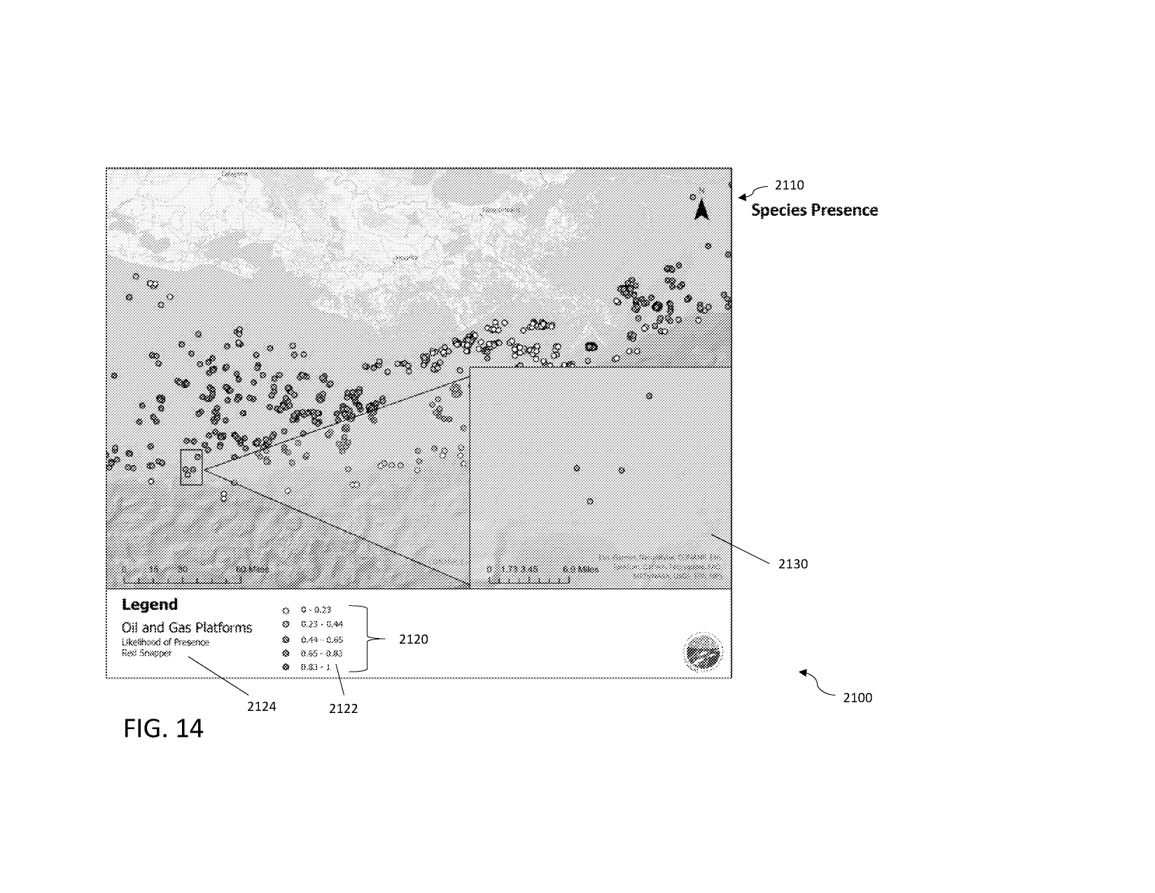

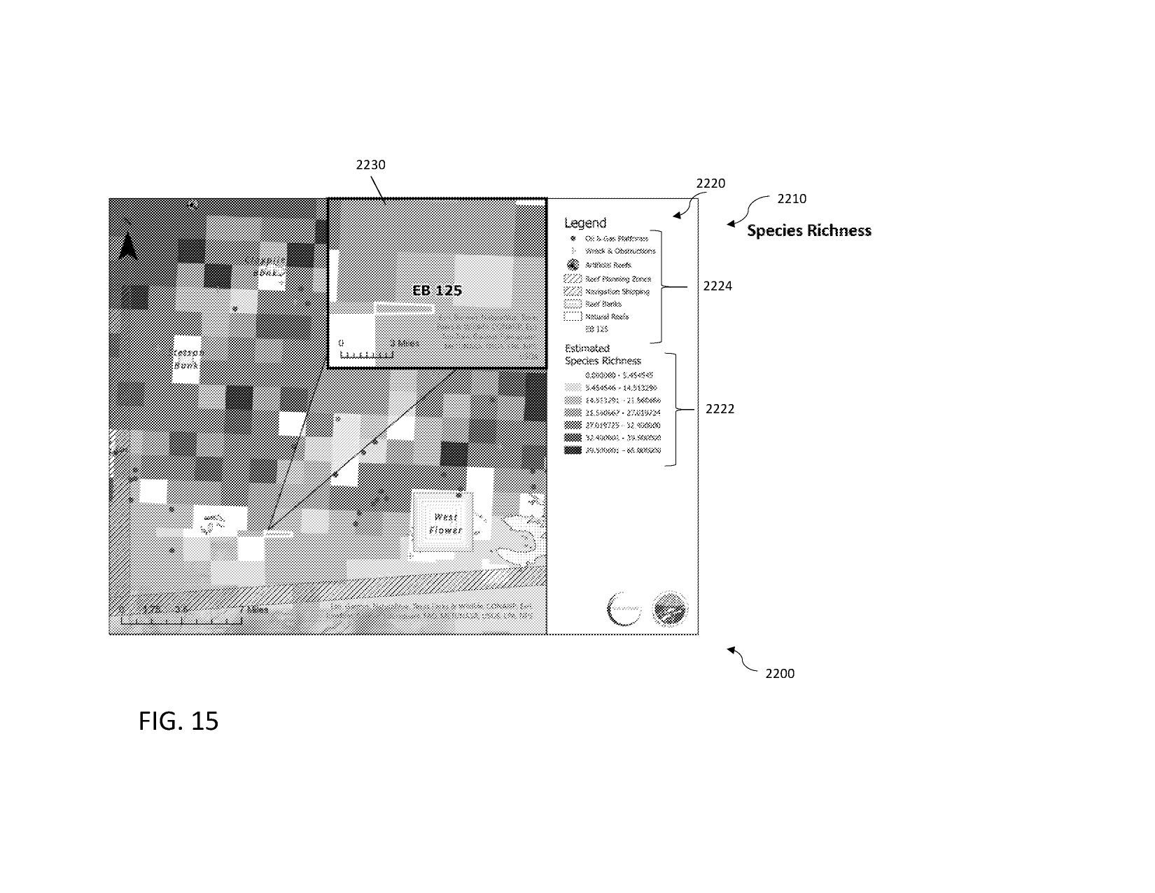

As shown in FIG. 10, when the Marine Life tab 1259 is selected on the Overview GUI 1200 (FIG. 6A), the Fisheries GUI 1300 (FIG. 7), the Vessel Traffic GUI 1400 (FIG. 8), or the Habitat GUI 1500 (FIG. 9), the FishLAT app 124A, 154A, or 160A invokes and exhibits a Marine Life GUI 1600 of the Interactive Dashboard 290, 390, 490. The Marine Life GUI 1600 exhibits fish species-related information within a region, labeled “Fish Species” and shown generally at 1610, from the corresponding one of the site profiles 162 within the data storage device 160 for the specified site 1162. In one embodiment, the FishLAT app 124A, 154A, or 160A exhibits the fish species-related information within the user-defined or system defined radius of the specified site 1162. As shown in FIG. 10, the fish species-related information within the region 1610 includes an indication of a probability of encountering one or more fish species at the specified site 1162, which also relates to a likelihood of species presence around a given site. In some cases, the probability of encounter and the likelihood of species presence may be seen to provide an indication of species richness about the specified site 1162. In one embodiment, the probability of encounter is exhibited as, for example, a bar graph shown generally at 1612, within the region 1610. The bar graph 1612 provides the probability of encounter as, for example, a list of the one or more fish species shown generally at 1614 on, for example, a vertical or y-axis of the bar graph 1612, and a percentage of the fish species as compared to a total of the species present at the specified site 1162 shown generally at 1616 on, for example, a horizontal or x-axis of the bar graph 1612. It should be appreciated that it is within the scope of the present disclosure for the FishLAT system 100 to exhibit the fish species-related information in other formats. In some embodiments, the probability of encounter exhibited as the bar graph 1612 is an example of the probability scores/maps 284 and 384 output by the FishLAT system 100 as shown in FIGS. 1 to 4. It should also be appreciated that the FishLAT system 100 permits review of data, e.g., fish species-related and other data and information in various formats. For example, FIG. 10 provides fish species information as the probability of encounter output, which relates to the likelihood of species presence around a given site, and FIG. 14 depicts the likelihood of presence for a specific species, namely, Red Snapper. Additionally, although FIG. 10 does not display species richness directly, it relates to, for example, the generated output depicted on FIG. 15, by visualizing probability data, and providing spatial context by showing the proximity to the nearest coral reef. Accordingly, the FishLAT system 100 creates continuity between the generated probability maps and other generated output.

In one embodiment, the Marine Life GUI 1600 also includes a region, shown generally at 1630, exhibiting other fish species-related information that may include, for example, an estimate of the connectivity of the fish species, including migratory patterns and proximity to known habitats, and the specified site 1162 presented in, for example, a Connectivity Estimate field 1632 and a calculated distance to the nearest coral reef, allowing users to assess, for example, the potential influence of coral ecosystems on the species’ distribution and behavior at the site 1162 within a Closest Coral Observation field 1634. As also shown in FIG. 10, the Marine Life GUI 1600 includes a region, shown generally at 1660, that exhibits the sites or areas of interest 1162 within proximity to a marine location under analysis within the system 100 (e.g., the specified site), similar to the region 1160 of the Site Selection GUI 1100 (FIG. 5A), the region 1260 of the Overview GUI 1200 (FIG. 6A), the region 1360 of the Fisheries GUI 1300 (FIG. 7), the region 1460 of the Vessel Traffic GUI 1400 (FIG. 8), and the region 1560 of the Habitat GUI 1500 (FIG. 9). Additionally, the Marine Life GUI 1600 includes a plurality of navigation elements, shown generally at 1650, similar to the navigation elements 1250 of the Overview GUI 1200 of FIG. 6A, the navigation elements 1350 of the Fisheries GUI 1300 of FIG. 7, the navigation elements 1450 of the Vessel Traffic GUI 1400 of FIG. 8, and the navigation elements 1550 of the Habitat GUI 1500 of FIG. 9, where the user/operator 10 may select options for viewing additional details of the specified site 1162 and information thereof stored within the data storage device 160. In one embodiment, the Marine Life GUI 1600 also includes an Additional Actions region, shown generally at 1640, where further functionality of the FishLAT system 100 may be invoked. For example, as depicted in FIG. 10, the Additional Actions region 1640 includes controls 1642 and 1644 for invoking functionality to preview a report for the specified site (e.g., by selecting a Preview Full Site Report control 1642) or for invoking functionality to add the specified site to a list of sites for comparison to other specified sites 1162 (e.g., by selecting a Add Site to Compare control 1644). In some embodiments, selection of the Add Site to Compare control 1644, instructs the FishLAT app 124A, 154A, or 160A to invoke and exhibit the Add Sites GUI 1280 of FIG. 6B to add one or more additional sites 1162 to the information provided on the Marine Life GUI 1600.

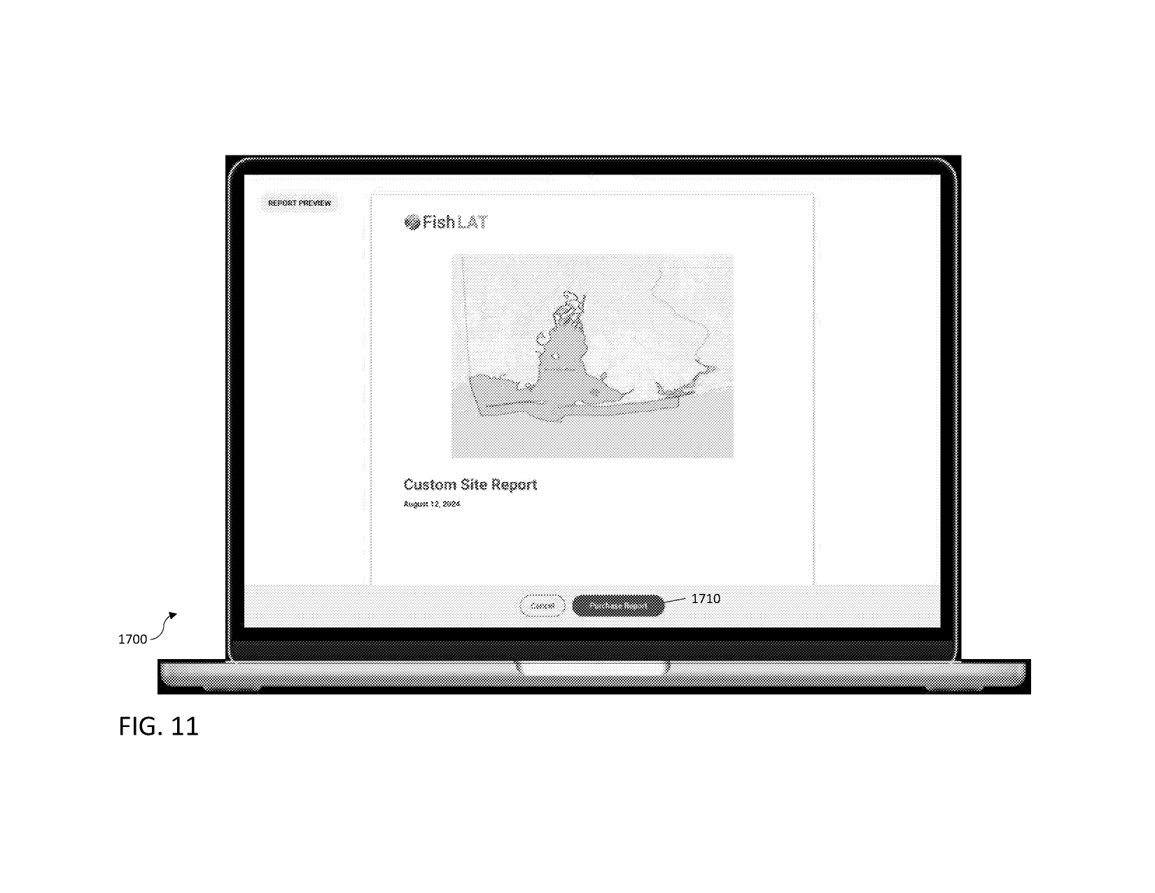

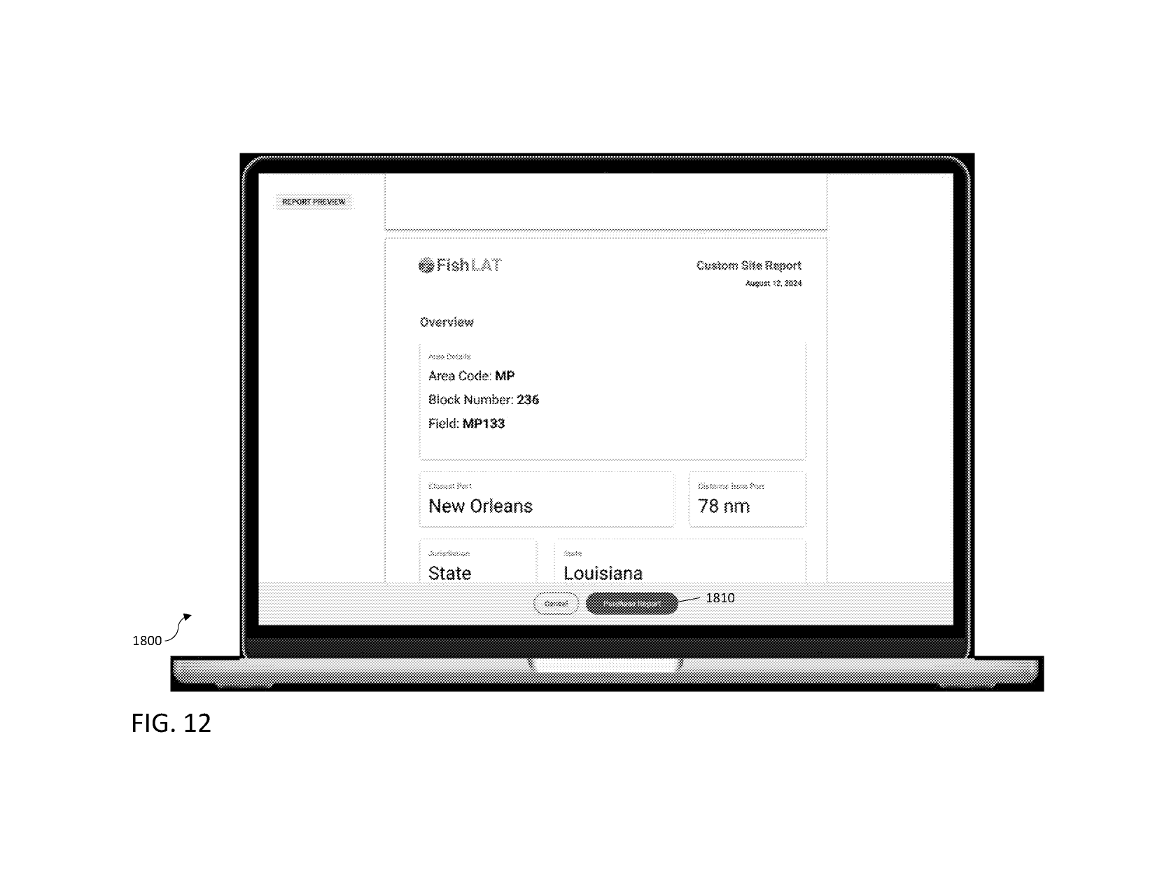

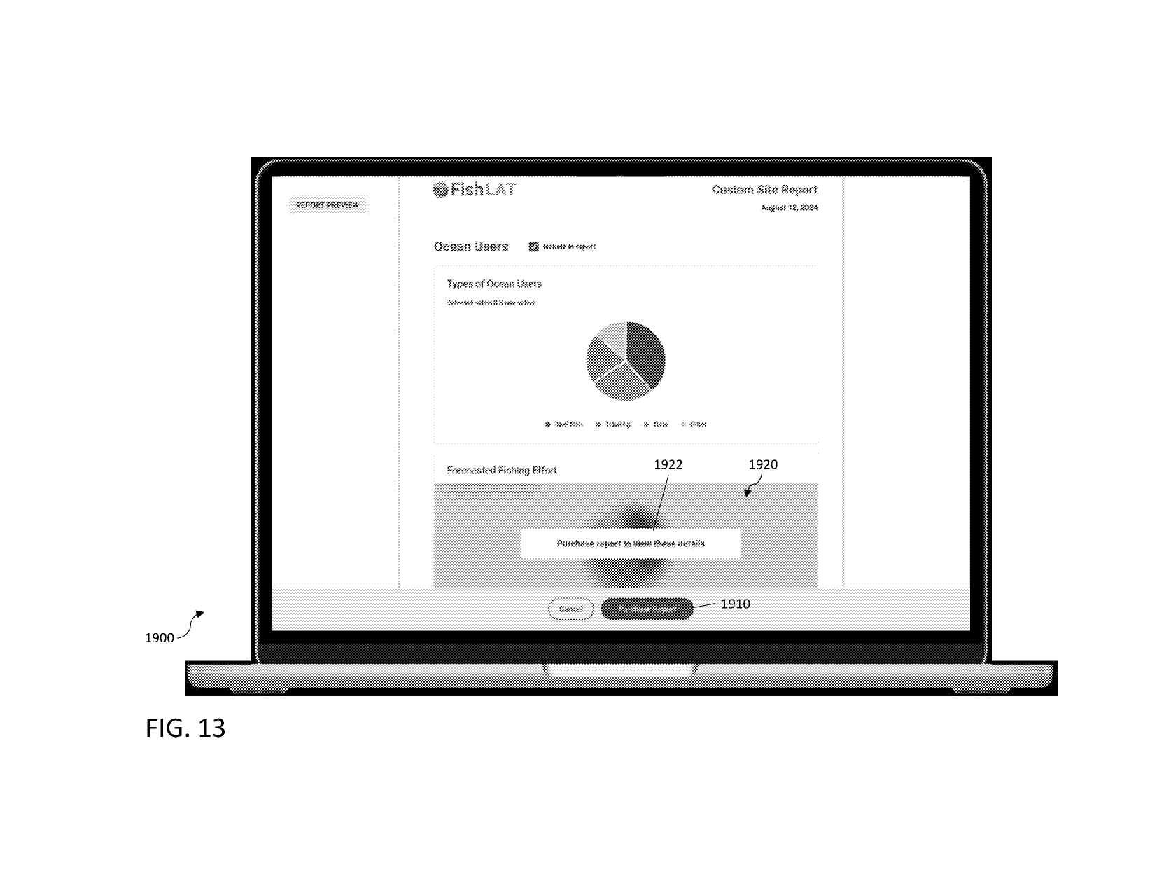

As shown in FIGS. 11 to 13, when a user 10 selects one of the controls to preview a full site report (e.g., the Preview Full Site Report controls 1242, 1342, 1442, 1542, and 1642 of FIGS. 6A to 10, respectively), the FishLAT app 124A, 154A, or 160A exhibits a plurality of GUIs, for example, GUIs 1700 (FIG. 11), 1800 (FIG. 12), and 1900 (FIG. 13), to provide portions of a Customized Site Report for viewing. In one embodiment, each of the GUIs 1700, 1800, and 1900 includes a Purchase Report control 1710, 1810, and 1910, respectively, for the user 10 to purchase a complete version of the Full Site Report. As shown in FIG. 13, in one embodiment, depending on a status of the user 10 (e.g., subscriber versus non-subscriber) the preview of certain information within the Preview Full Site Report view (GUIs 1700 to 1900) may be obfuscated, as shown generally at 1920, and a notification, e.g., a banner message 1922, is exhibited to the user 10 indicating that the information is available once the user 10 purchases a report or otherwise subscribes to the FishLAT system 100.

FIGS. 14 to 16 provide example portions of the reports 2000 output by the FishLAT system 100. As shown in FIG. 14, the reports 2000 generated by the system 100 may include a Species Presence report 2100 exhibited as, for example, a map, graph, table, or chart. As shown in FIG. 14, the Species Presence report 2100 for a specified species, for example, a Red Snapper species, is exhibited as a distribution map 2110. The distribution map 2110 exhibits a likelihood of the presence of a specified species modeled within and across a proximity of the plurality of sites or areas of interest of one or more marine locations under analysis within the system 100 such as, for example, a portion of the Gulf of Mexico and/or, in some embodiments, the Species Presence report 2100 presented may be habitat type specific. While depicted in FIG. 14 as the distribution map 2110, it should be appreciated that the FishLAT system 100 may present the information in a variety of formats such as, for example, a graph or chart, a table, or the distribution map. In some embodiments, as shown in FIG. 14, the Species Presence distribution map 2110 includes a legend, shown generally at 2120, that indicates the exhibited probability of presence provided as a percentage 2122 of the likelihood (e.g., a value of “1” or “100%”) that the specified species is present at one or more sites depicted in the map 2110, which species may be identified in the legend as shown at 2124. As shown in FIG. 14, a probability is depicted that a commercial valuable species of fish, namely, red snapper, occurs at one or more standing oil and gas platforms in the Gulf of Mexico. As also depicted in FIG. 14, in some embodiments, the Species Presence distribution map 2110 may include the user’s selection of a particular area 2130 which is presented in an enlarged view. In some embodiments, the Species Presence report 2100 exhibited as the distribution map 2110 is an example of the species distribution maps 282 and 382 output by the FishLAT system 100 as shown in FIGS. 1 to 4.

As shown in FIG. 15, the reports 2000 may also include a Species Richness report 2200 generated by the FishLAT system 100 and exhibited as, for example, a map, graph, table, or chart. As shown in FIG. 15, the Species Richness report 2200 exhibits a number or count of species that may be present or modeled within an ecological community at a geographic region or at or within proximity to specified marine locations, e.g., one or more of the sites 1162, as a distribution map 2210. In some embodiments, as shown in FIG. 15, the Species Richness report 2200 includes a legend, shown generally at 2220, that indicates the count of the exhibited species 2222 at or in proximity to one or more marine locations 2224. As depicted in FIG. 15, in some embodiments, the Species Richness distribution map 2210 may include the user’s selection of a particular area 2230, for example, a lease block labeled “EB 125”, which is presented in an enlarged site-specific resolution or view. In some embodiments, the Species Richness report 2200 exhibited as the distribution map 2210 is another example of the species distribution maps 282 and 382 output by the FishLAT system 100 as shown in FIGS. 1 to 4.

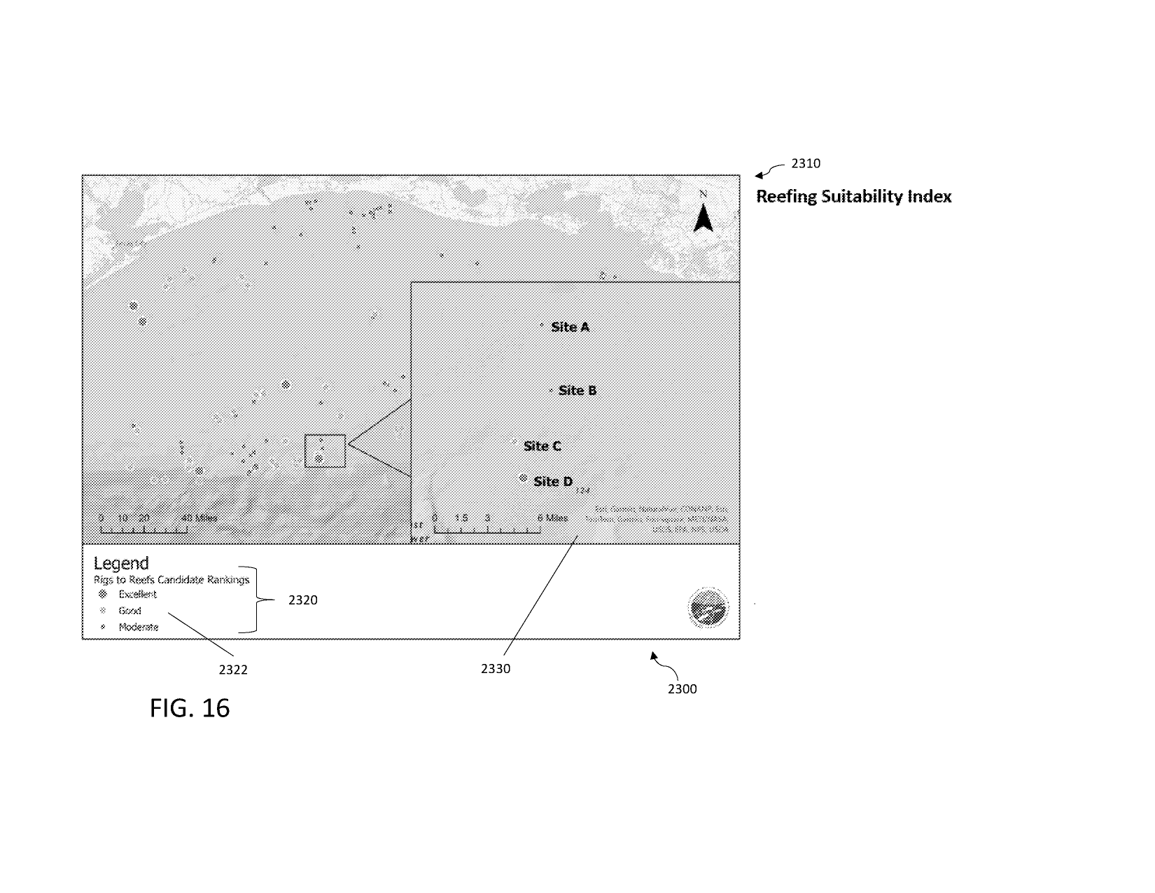

As shown in FIG. 16, the reports 2000 may include a Reefing Suitability Index report 2300 exhibited as, for example, a map, graph, table, or chart. As shown in FIG. 16, the Reefing Suitability Index report 2300 for one or more of the sites or areas of interest 1162 is exhibited as a distribution map 2310. The distribution map 2310 exhibits metrics like, for example, biodiversity and species distribution, modeled across or within proximity to the one or more sites or areas of interest 1162 within marine locations under analysis within the system 100 such as, for example, a portion of the Gulf of Mexico. In some embodiments, as shown in FIG. 16, the Reefing Suitability Index distribution map 2310 includes a legend, shown generally at 2320, that provides, for example, a rules-based comparative rating, ranking, and/or scoring, shown generally at 2322, across the one or more sites 1162 to identify perceived “best” candidates for development and/or reefing/decommissioning under rules including, for example, meeting or failing to meet, within predefined thresholds, of site ecology, probability of presence, accessibility, fishing effort, and/or legal or environmental compliance. In some embodiments as shown in FIG. 16, the comparative rating, ranking, and/or scoring 2322 may be presented by, for example, relative terms such as “Excellent,” “Good,” or “Moderate.” It should be appreciated that it is within the scope of the present disclosure to provide other means or terms of depicting the rules-based ranking such as, for example, an alphabetic, a numerical, and/or combined alphanumeric ranking or the like, which may also include the generated suitability score for each depicted site. As depicted in FIG. 16, in some embodiments, the Reefing Suitability Index distribution map 2310 may include the user’s selection of a particular area 2330 which is presented in an enlarged view for comparing specified sites of interest, for example, Sites A to D, where the Legend 2320 illustrates, for example, that Site D is a best candidate for reefing. In some embodiments, the Reefing Suitability Index report 2300 exhibited as the distribution map 2310 is an example of the biodiversity indices 286 and 386 and/or the Site Suitability scores 288 and 488 output by the FishLAT system 100 as shown in FIGS. 1 to 4.

Some perceived advantages of the FishLAT system 100 are seen to be its innovative implementation and use of forecast modeling for marine spatial planning, which enables the generation of project-specific assessments. Additionally, the FishLAT system 100 provides unique features by placing forecasting and scenario exploration models directly into the hands of stakeholders including, for example, regulatory agencies, fisheries, offshore industries, offshore energy sectors, and/or other users of the system 100. These features are seen to empower users 10 of the FishLAT system 100 with an ability to make more informed decisions for development, reefing/decommissioning, compliance, and planning requirements. For instance, users 10 can explore different scenarios (e.g., the above-described exploration, development, and/or decommissioning scenarios 166) within the FishLAT system 100 to forecast changes in stakeholder behavior such as, for example, when infrastructure is added or removed. This approach is seen to lead to outcomes that optimize benefits for ocean users and the environment, while simultaneously minimizing risks and costs for all involved parties.

Some perceived improvements provided by the FishLAT system 100 as compared to conventional technologies include, for example:

Integrated Machine Learning Approach: Combines multiple machine learning models and algorithms implemented within the system 100 to provide a comprehensive and robust predictive framework, improving accuracy and reliability compared to existing single-model approaches;

Holistic Data Integration: The FishLAT system 100 provides a unified platform that integrates diverse data sources, enhancing the depth and breadth of analysis. Existing technologies often struggle with fragmented data, leading to less reliably generated predictions;

Enhanced User Experience: The FishLAT system 100 generates interactive dashboards and visualization tools (e.g., within its GUIs 1000 and reports 2000), making complex data accessible and actionable. This user-centric design improves stakeholder engagement and decision-making, which is often lacking in traditional tools; and

Continuous Learning and Adaptation: Incorporates real-time updates and continuous learning from new data, ensuring the FishLAT system 100 remains relevant and accurate over time. This dynamic capability is a significant improvement over static models that do not adapt to changing conditions and/or permit ad-hoc initiation of exploration and/or decommissioning scenarios 166 and generation of revised output in response thereto.

Some perceived inventive aspects of the FishLAT system 100 as compared to conventional technologies include, for example:

The use of advanced ML algorithms for marine spatial planning including Random Forest 242 and 342 and Linear Regression 244 and 344 models that employ, as implemented within the FishLAT system 100, ensemble learning techniques to generate predictions of species richness and the probability of presence with high accuracy by considering a multitude of environmental variables such as, for example, depth, habitat type, sediment composition, and water temperature. This approach is seen to enhance prediction reliability and reduce overfitting. The models implemented within the system utilize linear relationships between environmental variables and species presence to generate straightforward yet effective predictions about biodiversity and species distribution. As implemented, the ML algorithms also include use of the Suitability Model 248 and 448 that integrates multiple criteria to evaluate and rank, in accordance with defined rules and thresholds, the suitability of different sites for development and/or decommissioning projects as meeting or failing to meet, for example, regulatory and/or industry criteria. This model incorporates domain-specific knowledge and ML techniques, providing a comprehensive assessment tool for site selection.

The FishLAT system 100 uses comprehensive data integration and processing including unified data platform that integrates diverse data sources including, for example, satellite imagery, underwater sensors, and historical records, into a cohesive dataset. This unified approach ensures comprehensive analysis and enhances the robustness of generated predictions. The use of advanced data augmentation that employs techniques to enhance datasets with, for example, synthetic examples geared to improve model training and performance. This is seen to result in the generation of more accurate and generalized models capable of evaluating varying environmental conditions. The use of automated data processing that implements methods such as, for example, automated cleaning, normalization, and feature engineering processes, streamlining data preparation, and ensuring high-quality inputs for model training.

The use of enhanced predictive capabilities and generation of data presented on user interfaces and reports (e.g., GUIs 1000 and reports 2000) including generated species distribution and biodiversity prediction to provide precise predictions on species presence and biodiversity indices, aiding in marine conservation efforts and sustainable fisheries management. The use of interactive dashboards 290, 390, and 490 and visualization tools (e.g., the GUIs 100 and reports 2000) that enable stakeholders to easily interpret data and insights. This enhances decision-making processes by making complex data accessible and understandable. The enhanced predictive capabilities also include real-time generation of predictions and continuous updates to predictions based on new data inputs that ensures that users have access to the most current and accurate information. This feature supports dynamic and adaptive marine management strategies.

The use of specific applications to provide practical benefits including optimized artificial reef placement to assist organizations like, for example, the Coastal Conservation Association, identify optimal locations for artificial reefs, maximizing ecological and economic benefits. The incorporation of evaluation techniques similar to, for example, the Rigs-to-Reefs Program evaluations, to provide, for example, oil and gas companies, with detailed feasibility assessments for repurposing offshore infrastructure such as, for example, oil and gas platforms, as artificial reefs to support cost-effective and environmentally beneficial development and/or decommissioning decisions. Also, the support of marine spatial planning aids government agencies and regulators at, for example, local, state, national and/or international levels, in designing marine protected areas and in making informed zoning decisions, promoting sustainable development and conservation.

The use of scalable and adaptable architecture and methodology. The scalable architecture implemented within the FishLAT system 100 is designed to handle large datasets and complex calculations, making it suitable for extensive marine environments and various geographical regions. The FishLAT system 100 is adaptable/customizable to different marine conditions, environments, and requirements, thus providing a versatile tool for a wide range of marine spatial planning and conservation applications.

It should be appreciated that the phraseology and the terminology used in the description of the various embodiments described herein should be given their broadest interpretation and meaning as the purpose is for describing particular embodiments only and is not intended to be limiting. As used in the description of the various described embodiments and the appended claims, the singular forms “a,” “an,” and “the” are intended to include the plural forms as well, unless the context clearly indicates otherwise. It should also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, and equivalents thereof, and do not preclude the presence or addition of one or more other features, integers, steps, operations, elements, components, groups and/or equivalents thereof. It should also be understood that the term “computer program product” includes logic presented by computer code and instructions embodied in or on the computer program product that is executed and executable by one or more computing devices to implement and/or perform functionality or operations as described herein.

While the invention has been described with reference to various exemplary embodiments, including, for example, an implementation as a fishery location assessment system and method for assessing environmental and economic impacts of offshore infrastructure development and decommissioning projects based on received marine data processed to generate predictions of environmental conditions that meet or fail to meet regulatory or industry criteria, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for assessing environmental, fisheries-related, and economic impacts of offshore infrastructure development and decommissioning, the system comprising:
a server including a server processor and a server memory operatively coupled to the server processor, the server memory storing server instructions executable by the server processor; and
one or more user devices, operable by one or more users of the system, each of the one or more user devices including a user device processor, a user device memory operatively coupled to the user device processor, and a user device display operatively coupled to the user device processor and exhibiting a plurality of graphical user interfaces (GUIs) thereon, the one or more user devices communicating with the server over a communication network, each of the user device memory storing user device instructions executable by the user device processor;
the server processor, when executing the server instructions, is configured to:
receive, over the communication network, unclassified marine data for a plurality of sites of interest;
pre-process the received unclassified marine data to generate one or more predictive models including classified data representative of generated predictions of environmental conditions and a generated degree in which the predicted environmental conditions at least one of meets or fails to meet, in accordance with one or more sets of rules and within one or more predefined thresholds, at least one of regulatory criteria or industry criteria;
receive a dataset of unclassified marine data for a specified site of interest;
present the received dataset of unclassified marine data for the specified site to one or more ML algorithms that use the one or more sets of rules and the generated one or more predictive models to evaluate the received dataset and to generate, in accordance with the one or more sets of rules, a suitability ranking for the specified site of interest for development or decommissioning based on a comparison to the generated predictions of environmental conditions and including within the suitability ranking a generated degree that the specified site meets or fails to meet, within at least one of the predefined thresholds, the at least one of regulatory criteria or industry criteria; and
host the plurality of GUIs operable to review the generated suitability ranking and generated degree of meeting or failing to meet the regulatory or industry criteria for the specified site of interest;
the user device processor, when executing the user device instructions, is configured to:
review, by invoking one of the plurality of GUIs, the generated output for one or more of the specified sites of interest;
update, by invoking one of the plurality of GUIs, a value of within the dataset of unclassified marine data; and
generate a request to the server processor to reprocess the updated dataset of unclassified marine data to simulate one or more scenarios for development and/or decommissioning and to generate a new suitability ranking and a degree of meeting or failing to meet the regulatory or industry criteria in response thereto.

2. The system of claim 1, wherein the one or more sets of rules for meeting at least one regulatory criteria or industry criteria include site ecology including biodiversity and species richness, probability of presence of one or more species of interest, accessibility to ports or user communities of interest, predicted fishing effort, compliance with legal or environmental requirements including species protection zones, essential species designations, or exclusion zones, and operational safety margins, proximity to existing infrastructure or shipping lanes, bathymetric or sediment conditions acceptable for development or decommissioning projects.

3. The system of claim 1, wherein the server processor, when executing the server instructions, is further configured to store a site profile for the specified site of interest, the site profile including the unclassified marine data and the generated output for the specified site.

4. The system of claim 1, wherein the unclassified marine data for the plurality of sites of interest and the specified site of interest includes physical characteristics of the sites, environmental conditions of the sites, marine life data at the sites, and infrastructure data at the sites.

5. The system of claim 4, wherein the physical characteristics of the sites include a depth, a substrate type, and a sediment composition of each of the sites.

6. The system of claim 4, wherein the environmental conditions of the sites include water temperature, salinity, and water quality of each of the sites.

7. The system of claim 4, wherein the marine life data of the sites includes species presence and species absence about each of the sites.

8. The system of claim 4, wherein the infrastructure data at the sites includes locations and types of existing or proposed infrastructure including at least one of oil platforms, piping, artificial reefs, and structures within lease blocks.

9. The system of claim 4, wherein the unclassified marine data further includes fishing tracking data.

10. The system of claim 9, wherein the fishing tracking data is provided by the National Oceanographic and Atmospheric Administration.

11. A method for assessing environmental, fisheries-related, and economic impacts of offshore infrastructure development and decommissioning, the method comprising:
providing a server processor and a server memory operatively coupled to the server processor, the server memory storing server instructions executable by the server processor; and
providing one or more user devices each including a user device processor, a user device memory operatively coupled to the user device processor, and a user device display operatively coupled to the user device processor and exhibiting a plurality of graphical user interfaces (GUIs) thereon, the one or more user devices communicating with the server over a communication network, each of the user device memory storing user device instructions executable by the user device processor;
receiving, by the server processor, unclassified marine data for a plurality of sites of interest;
pre-processing the received unclassified marine data to generate one or more predictive models including classified data representative of predicted environmental conditions that meet or fail to meet, in accordance with one or more sets of rules and within one or more predefined thresholds, at least one of regulatory criteria or industry criteria;
receiving a dataset of unclassified marine data for a specified site of interest;
presenting the received dataset of unclassified marine data for the specified site to one or more ML algorithms that used the one or more sets of rules and the generated one or more predictive models to evaluate the received dataset and to generate, in accordance with the one or more sets of rules, output representative of a suitability of the specified site of interest for development or decommissioning based on the predicted environmental conditions at the specified site meeting or failing to meet, within at least one of the predefined thresholds, the at least one of regulatory criteria or industry criteria; and
hosting, by the server processor, the plurality of GUIs operable to review the generated output for the specified site of interest;
reviewing, by the user processor invoking one of the plurality of GUIs, the generated output for the specified site of interest;
updating, by invoking one of the plurality of GUIs, a value of within the dataset of unclassified marine data; and
generating, by the user processor a request to the server processor to reprocess the updated dataset of unclassified marine data to simulate one or more scenarios for development and/or decommissioning and generation new output in response thereto.

12. The method of claim 11, wherein the one or more sets of rules for meeting at least one regulatory criteria or industry criteria include site ecology including biodiversity and species richness, probability of presence of one or more species of interest, accessibility to ports or user communities of interest, predicted fishing effort, compliance with legal or environmental requirements including species protection zones, essential species designations, or exclusion zones, and operational safety margins, proximity to existing infrastructure or shipping lanes, bathymetric or sediment conditions acceptable for development or decommissioning projects.

13. The method of claim 11, wherein the unclassified marine data for the plurality of sites of interest and the specified site of interest includes physical characteristics of the sites, environmental conditions of the sites, marine life data at the sites, and infrastructure data at the sites.

14. The method of claim 13, wherein the physical characteristics of the sites include a depth, a substrate type, and a sediment composition of each of the sites.

15. The method of claim 13, wherein the environmental conditions of the sites include water temperature, salinity, and water quality of each of the sites.

16. The method of claim 13, wherein the marine life data of the sites includes species presence and species absence about each of the sites.

17. The method of claim 13, wherein the infrastructure data at the sites includes locations and types of existing or proposed infrastructure including at least one of oil platforms, piping, artificial reefs, and structures within lease blocks.

18. The method of claim 13, wherein the unclassified marine data further includes fishing tracking data.

19. The method of claim 18, wherein the fishing tracking data is provided by the National Oceanographic and Atmospheric Administration.
